(19) United States
(12) Patent Application Publication
(10) Pub. No.: US 2015/0057382 A1
(43) Pub. Date: Feb. 26, 2015

(54) RESIN COMPOSITION FOAM AND METHOD FOR PRODUCING THE SAME

(71) Applicant: Mitsubishi Rayon Co., Ltd., Chiyoda-ku (JP)

(72) Inventors: Ali Rizvi, Toronto (CA); Chul Park, Etobicoke (CA); Masayuki Yamaguchi, Nomi-shi (JP)

(73) Assignee: Mitsubishi Rayon Co., Ltd., Chiyoda-ku (JP)

(21) Appl. No.: 14/384,088

(22) PCT Filed: Mar. 13, 2013
(86) PCT No.: PCT/JP13/56973

§ 371 Date: Sep. 9, 2014

(30) Foreign Application Priority Data
Mar. 13, 2012 (JP) 2012-055873

(51) Int. Cl. C08J 9/12; C08J 9/00

(52) U.S. Cl. CPC C08J 9/122; C08J 9/0061; C08J 2323/12; C08J 2427/18; C08J 2203/08; C08J 2205/052; C08J 2205/05; C08J 2203/06
USPC 521/81; 521/97; 521/134

(57) ABSTRACT

The present invention relates to a method for producing a resin composition foam comprising dissolving a supercritical fluid in a resin composition containing polytetrafluoroethylene and another resin other than polytetrafluoroethylene at a temperature equal to or higher than a glass transition point of the other resin, then foaming the resin composition by removing the supercritical fluid at a temperature lower than a temperature obtained by adding 15° C. to a thermal deformation starting temperature of the other resin, and subsequently cooling. In addition, the present invention relates to a resin composition foam, wherein the resin composition foam has a pore size of less than 50 μm, and the resin composition foam is any one of an open cell, a closed cell and a monolith type.

### TECHNICAL FIELD

The present invention relates to a resin composition foam and a method for producing the same.

This application is based upon and claims the benefit of priority of the prior Japanese Patent Application No. 2012-055873, filed on Mar. 13, 2012, the entire contents of which are incorporated herein by reference.

### BACKGROUND ART

The development of a foam having fine pores (cell) therein in dense leads to the weight saving of the industrial products and the reduction in use of resources, and thus the development of the products imparted with functionality such as cushioning properties, buoyancy, thermal insulating properties, and electrical properties is possible. The usefulness of a foam is further enhanced when a thermoplastic resin or a thermosetting resin which exhibits excellent in moldability is used as a material of the foam.

In addition, a foam has a structure such as an open cell type in which the interfaces between cells interconnect, a closed cell type in which cells are independent of each other, or a monolith type having through holes partitioned by a partition wall, and a foam having a suitable structure for each application is used.

In recent years, the social expectation has been given to the development of a technology to produce a foam having a further dense and fine structure by utilizing carbon dioxide or the like which exhibits high solubility in a resin and is in a supercritical state in order to improve the production process of a foam using Freon, butane, or the like that is a burden on the global environment.

For example, a propylene-based resin is a material producible by an industrially relatively simple raw material and process, excellent in economic efficiency and environmental suitability, and excellent in a balance between mechanical performance and thermal performance, and is one resin used for general purposes among the thermoplastic resins. For that reason, particularly an increase in the cell density by controlling the structure of a foam and improving the denseness and fineness of a foam in the case of using a propylene-based resin as a material of a foam is expected to lead to not only the development of a product to meet the social expectation and the promotion of use thereof but also the utilization of new functionality and the stimulation of demand.

However, the generally used propylene-based resin itself is not suitable for foam moldability and thus various improvements have been made so far. For example, a propylene-based resin obtained by introducing a branched structure into the polymer chain or a propylene-based resin composition obtained by compounding an inorganic material has been proposed. Moreover, it has been reported that the melt tension of the propylene-based resin is improved by the effect of the branched polymer structure or the crystallinity of the propylene-based resin affects cell nucleation and growth, which is generally well known.

However, an industrially special process is included in the synthesis of the propylene-based resin obtained by introducing a branched structure into the polymer chain, and thus there is a problem that the versatility that is the original specialty of the propylene-based resin is lost, or the like. Hence, a method is required by which a fine-cell foam can be produced, for example, only by adding a small amount of an additive to the propylene-based resin used for general purposes so far.

Accordingly, a method is generally well known in which a fibrous structure is formed in the thermoplastic resin using a small amount of polytetrafluoroethylene so as to improve the tension of the molten resin. With regard to the propylene-based resin as well, a foam of a resin composition containing a linear or branched propylene-based resin and polytetrafluoroethylene has been reported.

For example, a propylene-based resin foam is disclosed in Patent Document 1 which is obtained by foaming a resin composition containing a linear or branched propylene-based resin and polytetrafluoroethylene at 190° C. using carbon dioxide as a foaming agent, and it is considered that the propylene-based resin foam thus obtained is excellent in the independence of the cell. According to this method, it is possible to suppress drawdown of the molten resin in the production process of the foam and it is also possible to suppress the deformation of the cell as a side effect.

In addition, a propylene-based resin foam is disclosed in Patent Document 2 which is obtained by foaming a resin composition containing polypropylene having a melt flow rate of from 0.1 to 7 g/10 minutes and a mixed powder composed of polytetrafluoroethylene particles and an organic polymer in specific amounts using isobutane as a foaming agent. According to this method, a foam having a high expansion ratio can be obtained.

### CITATION LIST

### Patent Document

Patent Document 1: JP 2001-220459 A

Patent Document 2: JP 11-322991 A

### DISCLOSURE OF THE INVENTION

### Problem to be Solved by the Invention

However, the structure of the propylene-based resin foam obtained by the method described in Patent Document 1 is poor in denseness and fineness since the variation in the shape of the cells is significant, the interval of the cells is wide, or the like. In addition, the cell density of the foam is also low.

Meanwhile, it is difficult to increase the expansion ratio while maintaining the fineness of the cell since the effect of adding polytetrafluoroethylene in the case of using a foaming agent (for example, isobutene or the like) other than a supercritical fluid as a foaming agent is the growth of a cell.

In the method described in Patent Document 2, a foam having a high expansion ratio can be obtained but the cell is large in size so that the cell can be confirmed visually and thus the foam does not always satisfy fineness.

As described above, it is the existing circumstance that a method for producing a foam having a high expansion ratio, excellent in denseness and fineness, and having a high cell density by controlling the structure of the foam using a resin composition containing polytetrafluoroethylene has not been proposed yet.

In other words, it is required that a method for producing a foam have a high expansion ratio and a high cell density by controlling the structure through the densification and refinement of the structure of the foam in order to provide a foamed material excellent in functionality, moldability, and environmental suitability.

An object of the invention is to provide a method for producing a resin composition foam having a high expansion ratio, excellent in denseness and fineness, and having a high cell density by controlling the structure of the resin composition foam.

Another object of the invention is to provide a resin composition foam having a high expansion ratio, excellent in denseness and fineness, and having a high cell density.

### Means for Solving Problem

As a result of intensive investigations, the present inventors have found out that the nucleation and growth of cell can be optimized by specifying the dissolving temperature and the foaming temperature in the production condition using a supercritical fluid as a foaming agent with respect to a resin composition added with polytetrafluoroethylene, thereby the invention has been completed.

In other words, the invention has the following features.

<1> A method for producing a resin composition foam including dissolving a supercritical fluid in a resin composition containing polytetrafluoroethylene and another resin other than polytetrafluoroethylene at a temperature equal to or higher than a glass transition point of the other resin, then foaming the resin composition by removing the supercritical fluid at a temperature lower than a temperature obtained by adding 15° C. to a thermal deformation starting temperature of the other resin, and subsequently cooling.

<2> A method for producing a resin composition foam including dissolving a supercritical fluid in a resin composition containing polytetrafluoroethylene and another resin other than polytetrafluoroethylene at a temperature lower than a glass transition point of the other resin over a time longer than 30 minutes, then foaming the resin composition by removing the supercritical fluid at a temperature lower than a temperature obtained by adding 15° C. to a thermal deformation starting temperature of the other resin, and subsequently cooling.

<3> The method for producing a resin composition foam according to <1> or <2>, in which the resin composition contains a foam regulator (C).

<4> The method for producing a resin composition foam according to any one of <1> to <3>, in which the other resin is an olefin-based resin.

<5> The method for producing a resin composition foam according to any one of <1> to <4>, in which the other resin contains a resin which is linear and has a melt flow rate measured in conformity with ISO 1133: 1997 (JIS K 7210: 1999) of more than 0.5 g/10 minutes at 60% by mass or more in 100% by mass of the other resin.

<6> The method for producing a resin composition foam according to any one of <1> to <5>, in which the resin composition is foamed by extrusion foaming.

<7> A resin composition foam, the resin composition foam being obtained by the method for producing a resin composition foam according to any one of <1> to <6> and does not contain a pore of more than 500 μm.

<8> A resin composition foam, in which the resin composition is obtained by the method for producing a resin composition foam according to any one of <1> to <6> and has pores formed at an interval of less than 10 μm.

<9> A resin composition foam, the resin composition foam being obtained by the method for producing a resin composition foam according to any one of <1> to <6> and is a closed cell type.

<10> The resin composition foam according to <9>, the resin composition foam is a closed cell type having an expansion ratio of more than 2.3 times.

<11> A resin composition foam, the resin composition foam being obtained by the method for producing a resin composition foam according to any one of <1> to <6> and is an open cell type.

<12> The resin composition foam according to <11>, in which the resin composition foam is an open cell type having pores of different sizes interconnected regularly at a proportion of 50% or more.

<13> A resin composition foam, the resin composition foam being obtained by the method for producing a resin composition foam according to any one of <1> to <6> and is a monolith type having a plurality of through holes partitioned by a partition wall.

<14> The method for producing a resin composition foam according to any one of <1> to <6>, in which the supercritical fluid is injected at 0.3 part by mass or more with respect to 100 parts by mass of the resin composition.

<15> The method for producing a resin composition foam according to any one of <1> to <5> and <14>, in which the resin composition is foamed by batch foaming.

<16> A resin composition foam, the resin composition foam being obtained by the method for producing a resin composition foam according to any one of <1> to <6>, <14>, and <15> and has an expansion ratio of more than 1.8 times.

<17> A resin composition foam, the resin composition foam being obtained by the method for producing a resin composition foam according to any one of <1> to <6>, <14>, and <15> and is a monolith type having an expansion ratio of more than 1.2 times.

<18> A resin composition foam, in which the resin composition foam has a pore size of less than 50 μm, an expansion ratio of more than 5 times, a cell density of more than 10¹⁰ cells/cm³, and an open cell ratio of more than 90%.

<19> A resin composition foam, in which the resin composition foam being is a closed cell type having a pore size of less than 50 μm, an expansion ratio of more than 30 times, and a cell density of more than 10⁸ cells/cm³.

<20> A resin composition foam, in which the resin composition foam is a monolith type having a pore size of less than 50 μm and a plurality of through holes partitioned by a partition wall.

### Effect of the Invention

According to the method for producing a resin composition foam of the invention, it is possible to produce a foam having a high expansion ratio, excellent in denseness and fineness, and having a high cell density by controlling the structure of the resin composition foam.

In addition, the resin composition foam of the invention has a high expansion ratio, excellent in denseness and fineness, and has a high cell density.

### BRIEF DESCRIPTION OF DRAWINGS

FIG. 1 is a scanning electron micrograph of the resin foam obtained in Example 13;

FIG. 2 is a scanning electron micrograph of the resin foam obtained in Example 14;

FIG. 3 is a scanning electron micrograph of the resin foam obtained in Example 15;

FIG. 4 is a scanning electron micrograph of the resin foam obtained in Example 16;

FIG. 5 is a scanning electron micrograph of the resin foam obtained in Example 17;

FIG. 6 is a scanning electron micrograph of the resin foam obtained in Example 18;

FIG. 7 is a scanning electron micrograph of the resin foam obtained in Comparative Example 4;

FIG. 8 is a scanning electron micrograph of the resin foam obtained in Comparative Example 5;

FIG. 9 is a scanning electron micrograph of the resin foam obtained in Comparative Example 6;

FIG. 10 is a scanning electron micrograph of the resin foam obtained in Comparative Example 7;

FIG. 11(a) is a scanning electron micrograph of the resin foam obtained in Example 35 and FIG. 11(b) is an enlarged view of FIG. 11(a);

FIG. 12(a) is a scanning electron micrograph of the resin foam obtained in Example 36 and FIG. 12(b) is an enlarged view of FIG. 12(a);

FIG. 13(a) is a scanning electron micrograph of the resin foam obtained in Example 37 and FIG. 13(b) is an enlarged view of FIG. 13(a);

FIG. 14 is a scanning electron micrograph of the resin foam obtained in Example 38;

FIG. 15 is a scanning electron micrograph of the resin foam obtained in Example 39;

FIG. 16 is a scanning electron micrograph of the resin foam obtained in Example 40;

FIG. 17 is a scanning electron micrograph of the resin foam obtained in Example 41;

FIG. 18 is a scanning electron micrograph of the resin foam obtained in Example 42;

FIG. 19 is a scanning electron micrograph of the resin foam obtained in Example 43;

FIG. 20 is a scanning electron micrograph of the resin foam obtained in Example 44;

FIG. 21 is a scanning electron micrograph of the resin foam obtained in Example 45;

FIG. 22 is a scanning electron micrograph of the resin foam obtained in Example 46;

FIG. 23 is a scanning electron micrograph of the resin foam obtained in Example 47;

FIG. 24 is a scanning electron micrograph of the resin foam obtained in Example 48;

FIG. 25 is a scanning electron micrograph of the resin foam obtained in Example 49;

FIG. 26 is a scanning electron micrograph of the resin foam obtained in Comparative Example 13;

FIG. 27 is a scanning electron micrograph of the resin foam obtained in Comparative Example 14;

FIG. 28 is a scanning electron micrograph of the resin foam obtained in Comparative Example 15;

FIG. 29 is a scanning electron micrograph of the resin foam obtained in Example 50;

FIG. 30 is a scanning electron micrograph of the resin foam obtained in Example 51;

FIG. 31 is a scanning electron micrograph of the resin foam obtained in Example 52;

FIG. 32 is a scanning electron micrograph of the resin foam obtained in Example 53;

FIG. 33 is a scanning electron micrograph of the resin foam obtained in Example 54;

FIG. 34 is a scanning electron micrograph of the resin foam obtained in Example 55;

FIG. 35 is a scanning electron micrograph of the resin foam obtained in Example 56;

FIG. 36 is a scanning electron micrograph of the resin foam obtained in Comparative Example 16;

FIG. 37 is a scanning electron micrograph of the resin foam obtained in Comparative Example 17;

FIG. 38 is a scanning electron micrograph (low magnification) of the resin foam obtained in Example 46;

FIG. 39 is a scanning electron micrograph (low magnification) of the resin foam obtained in Comparative Example 13;

FIG. 40 is a scanning electron micrograph (low magnification) of the resin foam obtained in Example 51;

FIG. 41 is a scanning electron micrograph (low magnification) of the resin foam obtained in Comparative Example 16;

FIG. 42 is a photograph of the resin foam obtained in Example 52;

FIG. 43 is a photograph of the resin foam obtained in Comparative Example 17; and

FIG. 44(a) is a scanning electron micrograph of the resin foam obtained in Example 57, and FIGS. 44(b) to 44(d) are enlarged views of FIG. 44(a).

### MODE(S) FOR CARRYING OUT THE INVENTION

Hereinafter, the invention will be described in detail.

Meanwhile, in the present specification, the term “(meth)acrylate” means acrylate and methacrylate, and “(meth)acrylic acid” means acrylic acid and methacrylic acid.

“Method for Producing Resin Composition Foam”

The method for producing a resin composition foam (hereinafter, referred to as the “resin foam”) of the invention is characterized in that a resin composition containing polytetrafluoroethylene (hereinafter, referred to as “PTFE”) and another resin other than PTFE (hereinafter, referred to as the “other resin”) is foamed using a supercritical fluid as a foaming agent.

### <Resin Composition>

The resin composition contains a polytetrafluoroethylene component (hereinafter, referred to as the “PTFE component”) composed of PTFE and a resin component composed of another resin. In addition, a foam regulator (C) is preferably contained therein.

### (PTFE Component)

The PTFE component is composed of PTFE.

As the PTFE component, for example, a polytetrafluoroethylene-containing powder (A) (hereinafter, referred to as the “PTFE-containing powder (A)”) can be mentioned, and polytetrafluoroethylene particles (a1) (hereinafter, referred to as the “PTFE particles (a1)”) and organic polymer particles (a2) can be contained in the PTFE-containing powder (A).

It is possible to produce a resin foam having a high expansion ratio, excellent in denseness and fineness, and having a high cell density as the resin composition contains the PTFE-containing powder (A).

The average particle size of the PTFE particles (a1) is preferably 10 μm or less, more preferably from 0.01 to 5.0 μm, and even more preferably from 0.05 to 1.0 μm.

In addition, the PTFE particles (a1) may be aggregated in the PTFE-containing powder (A), and in this case, it is preferable that an aggregate of a size having an average particle size of greater than 10 μm be not formed.

The dispersibility of the PTFE-containing powder (A) in a resin component to be described below is improved when the PTFE-containing powder (A) is mixed with the resin component in a case in which the average particle size of the PTFE particles (a1) or an aggregate thereof is 10 μm or less.

Meanwhile, the average particle size of the PTFE particles (a1) is a mass average particle size measured using a laser diffraction/scattering particle size distribution measuring apparatus.

The PTFE particles (a1) are obtained by, for example, emulsion polymerizing tetrafluoroethylene monomer using a fluorine-containing surfactant.

Upon the emulsion polymerization of the PTFE particles (a1), a copolymeric component copolymerizable with the tetrafluoroethylene monomer may be concurrently used within a range in which the properties of polytetrafluoroethylene are not impaired. Examples of the copolymeric component may include a fluorine-containing olefin such as hexafluoropropylene, chlorotrifluoroethylene, fluoroalkylethylene, or perfluoroalkyl vinyl ether; and a fluorine-containing alkyl (meth)acrylate such as perfluoroalkyl (meth)acrylate. The proportion of the copolymeric component is preferably 10 parts by mass or less with respect to 100 parts by mass of the tetrafluoroethylene monomer.

The resultant is obtained in the form of an aqueous dispersion having the PTFE particles (a1) dispersed in water when the tetrafluoroethylene monomer is emulsion polymerized. This aqueous dispersion of the polytetrafluoroethylene particles (hereinafter, referred to as the “PTFE particle aqueous dispersion”) can be used in the production of the PTFE-containing powder (A) as it is.

In addition, a commercially available product can be also used as the PTFE particle aqueous dispersion. Specific examples thereof may include “Fluon AD-1” and “Fluon AD-939L” manufactured by ASAHI GLASS CO., LTD.; “Polyflon D-1” and “Polyflon D-2” manufactured by DAIKIN INDUSTRIES, ltd.; and “Teflon (registered trademark) 30J” manufactured by Du Pont-Mitsui Fluorochemicals Co., Ltd.

The organic polymer particles (a2) is not particularly limited, but those exhibiting high compatibility with a resin component to be described below is preferable from the viewpoint of dispersibility when mixing with the resin component.

As the monomer to obtain such an organic polymer particles (a2), a monomer having an ethylenically unsaturated bond may be exemplified, and specific examples thereof may include a styrene-based monomer such as styrene, p-methylstyrene, o-methyl styrene, p-chlorostyrene, o-chlorostyrene, p-methoxystyrene, o-methoxy styrene, 2,4-dimethylstyrene, or α-methylstyrene; a (meth)acrylic acid ester-based monomer such as methyl acrylate, methyl methacrylate, ethyl acrylate, ethyl methacrylate, butyl acrylate, butyl methacrylate, 2-ethylhexyl acrylate, 2-ethylhexyl methacrylate, dodecyl acrylate, dodecyl methacrylate, tridecyl acrylate, tridecyl methacrylate, octadecyl acrylate, octadecyl methacrylate, cyclohexyl acrylate, or cyclohexyl methacrylate; a vinyl cyanide-based monomer such as acrylonitrile or methacrylonitrile; a vinyl ether-based monomer such as vinyl methyl ether or vinyl ethyl ether; a vinyl carboxylate-based monomer such as vinyl acetate or vinyl butyrate; an olefin-based monomer such as ethylene, propylene, or isobutylene; and a diene-based monomer such as butadiene, isoprene, or dimethyl butadiene. These monomers can be used singly or two or more kinds thereof can be mixed and used.

The molecular weight of PTFE is not particularly limited. For example, at the time of foaming, the molecular weight of PTFE is preferably high in a case in which the melt tension of the resin composition is required and the molecular weight of PTFE is preferably low in a case in which the dispersibility of PTFE in the resin is required.

As described in detail below, in the case of using a propylene-based resin (B) as a resin component, it is preferable to use a styrene-based monomer, a (meth)acrylic acid ester-based monomer, or an olefin-based monomer and it is particularly preferable to use one or more kinds of monomers selected from the group consisting of a long-chain or branched alkyl (meth)acrylic acid ester-based monomer having 4 or more carbon atoms, styrene, and an olefin-based monomer at 20% by mass or more in 100% by mass of the total monomer in order to obtain an organic polymer particles (a2) exhibiting excellent compatibility with the propylene-based resin (B).

The method for producing the organic polymer particles (a2) is not particularly limited, and examples thereof may include an emulsion polymerization method using an ionic emulsifier, a soap-free emulsion polymerization method using an ionic radical polymerization initiator, and an emulsion polymerization method using a redox-based radical polymerization initiator.

As the ionic emulsifier, any of an anionic emulsifier, a cationic emulsifier, an amphoteric emulsifier may be used. In addition, a nonionic emulsifier may be concurrently used together with these ionic emulsifiers if desired.

Examples of the anionic emulsifier may include a fatty acid salt, a higher alcohol sulfate ester salt, a liquid fatty oil sulfate ester salt, sulfate salts of aliphatic amine and aliphatic amide, an aliphatic alcohol phosphate ester salt, a sulfonic acid salt of a dibasic fatty acid ester, a fatty acid amide sulfonic acid salt, an alkyl aryl sulfonic acid salt, and a naphthalenesulfonic acid salt of a formalin condensate.

Examples of the cationic emulsifier may include an aliphatic amine salt, a quaternary ammonium salt, and an alkyl pyridinium salt.

Examples of the amphoteric ion emulsifier may include an alkyl betaine.

Examples of the ionic polymerization initiator may include an anionic polymerization initiator such as a persulfate salt (for example, potassium persulfate, ammonium persulfate, or the like), an azobis (isobutyronitrile sulfonate salt), or 4,4′-azobis(4-cyanovaleric acid); and a cationic polymerization initiator such as 2,2′-azobis(amidinopropane)dihydrochloride, 2,2′-azobis[2-(5-methyl-2-imidazoline-2-yl)propane]dihydrochloride, 2,2′-azobis[2-(2-imidazoline-2-yl)propane]dihydrochloride, or 2,2′-azobisisobutyramide dehydrate.

As the redox polymerization initiator, it is possible to use, for example, a peroxide such as tert-butyl hydroperoxide or cumene hydroperoxide and ferrous sulfate, ethylenediaminetetraacetic acid disodium salt, or ascorbic acid as a reducing agent in combination.

A chain transfer agent can be used at the time of polymerization, and examples thereof may include n-butyl mercaptan, n-octyl mercaptan, tert-dodecyl mercaptan, n-octadecyl mercaptan, and a-methylstyrene dimer.

The resultant is obtained in the form of an aqueous dispersion having the organic polymer particles (a2) dispersed in water when the emulsion polymerization is performed using the above described monomers which constitute the organic polymer particles (a2). This aqueous dispersion of the organic polymer particles can be used in the production of the PTFE-containing powder (A) as it is.

The average particle size of the organic polymer particles (a2) is not particularly limited, but it is preferable that the following Equation (1) be satisfied from the viewpoint of the stability of the state of aggregation with the PTFE particles (a1). Meanwhile, in Equation (1), “d” represents the average particle size of the organic polymer particles (a2) and “D” represents the average particle size of the PTFE particles (a1). In addition, the average particle size of the organic polymer particles (a2) is a mass average particle size measured using a laser diffraction/scattering particle size distribution measuring apparatus.

0.1D<d<10D (1)

The PTFE-containing powder (A) can be produced by a method of mixing a PTFE particle aqueous dispersion with an aqueous dispersion of the organic polymer particles and powdering the mixture thus obtained, a method of emulsion polymerizing a monomer for obtaining the organic polymer particles (a2) in the presence of the PTFE particle aqueous dispersion and then powdering the resultant thus obtained, or the like.

In addition, it is also possible to produce the PTFE-containing powder (A) by emulsion polymerizing a monomer having an ethylenically unsaturated bond in a mixed dispersion obtained by mixing a PTFE particle aqueous dispersion with an aqueous dispersion of the organic polymer particles and then powdering the resultant thus obtained.

As the monomer having an ethylenically unsaturated bond, it is possible to use the monomers having an ethylenically unsaturated bond which are previously exemplified as the monomer to obtain the organic polymer particles (a2) singly or by mixing two or more kinds thereof.

Examples of the method of powderization may include a method in which a mixed dispersion obtained by mixing a PTFE particle aqueous dispersion with an aqueous dispersion of the organic polymer particles or an aqueous dispersion after the emulsion polymerization in the PTFE particle aqueous dispersion is poured into hot water having a metal salt such as calcium chloride, magnesium sulfate, or calcium acetate dissolved therein, salted out, and coagulated, and then the coagulate is dried, a method in which the mixed dispersion or an aqueous dispersion after the emulsion polymerization is powdered by a spray dry, and the like.

Meanwhile, a usual polytetrafluoroethylene fine powder is likely to be an aggregate having an average particle size of 100 μm or more in the process of collecting as a powder from the form of a particle dispersion. Hence, it is difficult to disperse the powder uniformly in a resin component when mixing with the resin component.

However, it is difficult for the PTFE particles (a1) to form an aggregate of 100 μm or more since the PTFE-containing powder (A) used in the invention is a mixture of the PTFE particles (a1) and the organic polymer particles (a2). It is difficult for the PTFE particles (a1) alone to form an aggregate having an average particle size greater than 10 μm particularly when the PTFE particles (a1) having an average particle size of 10 μm or less is used. Consequently, the PTFE-containing powder (A) used in the invention is excellent in dispersibility in the resin component such as a propylene-based resin (B) to be described below.

The content of polytetrafluoroethylene in 100% by mass of the PTFE-containing powder (A) is preferably from 0.1 to 90% by mass.

In addition, the content of the PTFE-containing powder (A) in the resin composition is not particularly limited and it is possible to use a suitable amount to obtain a desired foam structure. However, as the content of the PTFE-containing powder (A) increases, the melt tension of the resin composition is improved, the breakage and coalescence of the cells are suppressed, and thus the denseness and fineness of the resin foam to be obtained are improved; meanwhile, moldability deteriorates in some cases.

There is a tendency that the occurrence of gas loss is suppressed by the addition of PTFE-containing powder (A), for example, in the case of batch foaming the resin composition.

The gas loss can be described, for example, as follows. The foaming agent escapes from the resin composition during the batch foaming in a case in which the foaming agent does not dissolve or is not kept in the resin composition, and thus the expansion ratio does not increase and coarse pores remain at a low density.

Furthermore, there is a tendency that the occurrence of gas pocket or melt fracture is suppressed in the resin foam to be obtained along with the addition of PTFE-containing powder (A) in the case of extrusion foaming the resin composition.

The gas pocket means a foam product defect especially here, is a coarse pore in the extrusion foamed body, and is a cause of a decrease in mechanical strength and optical properties. As an illustrative example of the generation process thereof, a cell nucleus is formed and grown in the case of a normally-foamed cell; meanwhile, the poor solubility of the foaming agent is considered as the cause in the case of gas pocket. It can be said that gas pocket is suppressed if a pore having a size of more than 200 μm is not observed, for example, when the cross-section of an extruded strand is observed by a scanning electron microscope.

The melt fracture means the expansion molding defect, for example, refers to an extruded product in a tortuous state, and is a cause of a decrease in the dimensional accuracy of a rod-shaped product and a plate-shaped product. It can be said that the melt fracture is suppressed, for example, when a strand extruded from a capillary type die has a smooth rod shape.

Incidentally, the PTFE-containing powder (A) may be pelletized with the resin component to be described below or master pelletized with a part of the resin component in some cases.

### (Resin Component)

The resin component is composed of another resin.

As the resin component, it is possible to use a known thermoplastic resin or thermosetting resin. An olefin-based resin is preferable and a propylene-based resin (B) is particularly preferable among them in consideration of the production method, mechanical properties, thermal properties, or the like.

The propylene-based resin (B) may be a homopolymer of propylene or a copolymer of propylene and an olefin (excluding propylene).

A linear structure or an uncrosslinked body tends to be superior in moldability of the structure of the resin foam to be obtained than a branched structure or a crosslinked body in the case of using a homopolymer as the propylene-based resin (B).

The olefin is not particularly limited as long as it is copolymerizable with propylene in the case of using a copolymer as the propylene-based resin (B), and examples thereof may include ethylene and an a-olefin having from 4 to 10 carbon atoms. These olefins may be used singly or by mixing two or more kinds thereof.

Examples of the α-olefin having from 4 to 10 carbon atoms may include 1-butene, isobutylene, 1-pentene, 3-methyl-1-butene, 1-hexene, 3,4-dimethyl-1-butene, 1-heptene, and 3-methyl-1-hexene.

The other resin (resin component) preferably contains a resin (hereinafter, referred to as the “resin (β)”) which is linear and has a melt flow rate (MFR) of more than 0.5 g/10 minutes. The molded appearance of the resin foam to be obtained is superior as the other resin contains the resin (β).

The MFR of the resin (β) is more than 0.5 g/10 minutes and preferably 3 g/10 minutes or more. There is a tendency that the molded appearance of the resin foam to be obtained deteriorates when the MFR is 0.5 g/10 minutes or less. The MFR of resin (β) is preferably 20 g/10 minutes or less and more preferably 10 g/10 minutes or less. There is a tendency that the fineness and denseness of the foamed cell of the resin foam to be obtained is easily impaired when the MFR is more than 20 g/10 minutes.

Meanwhile, the MFR of the resin (β) is a value measured in conformity with ISO 1133: 1997 (JIS K 7210: 1999).

Examples of the resin (β) may include the same resins as the olefin-based resins (particular a propylene-based resin (B)) described above.

The content of the resin (β) is preferably 60% by mass or more and more preferably 90% by mass or more in 100% by mass of the other resin (resin component). The molded appearance of the resin foam to be obtained is superior when the content of the resin (β) is 60% by mass or more.

The content of the resin component in the resin composition is not particularly limited and it is possible to use a suitable amount to obtain a desired foam structure. However, as the content of the resin component decreases, the melt tension of the resin composition is improved, the breakage and coalescence of the cells are suppressed, and thus the denseness and fineness of the resin foam to be obtained are improved; meanwhile, moldability deteriorates in some cases.

### (Foam Regulator (C))

Examples of the foam regulator (C) may include an inorganic powder such as talc or silica, an acidic salt of a polycarboxylic acid, and a reaction mixture of a polycarboxylic acid with sodium carbonate or sodium bicarbonate. Talc is preferable among these.

The content of the foam regulator (C) in the resin composition is not particularly limited and it is possible to use a suitable amount to obtain a desired foam structure. However, as the content of the foam regulator (C) increases, the denseness and fineness of the resin foam to be obtained are improved; meanwhile, the mechanical properties thereof deteriorate in some cases.

### (Another Component)

The resin composition can contain an additive such as an inorganic filler, a heat stabilizer, a ultraviolet absorber, an antioxidant, or a coloring agent if necessary.

Examples of the inorganic filler may include calcium carbonate, clays, zeolites, alumina, and barium sulfate (provided that, the foam regulator (C) is excluded). The elastic modulus or the heat resistance of the resin foam to be obtained is improved when the resin composition contains an inorganic filler, and thus it is possible to reduce the calories of combustion in the incineration.

### (Method for Producing Resin Composition)

The resin composition can be produced by a known method, and can be produced using, for example, a batch type kneader, a single screw extruder or a multi-screw extruder such as a twin screw extruder, a twin roll, or the like. Among these, a method using a twin screw extruder is preferable.

It is possible to use a known twin screw extruder in the case of producing the resin composition using a twin screw extruder, and, for example, twin screw extruders manufactured by TOSHIBA MACHINE CO., LTD., The Japan Steel Works, LTD., Werner & Pfleiderer, and Leistritz Advanced Technologies Corp. can be used.

In addition, the L/D (ratio of effective length/diameter) of the extruder screw is not particularly limited and is, for example, preferably from 3 to 300, more preferably from 10 to 200, even more preferably from 30 to 100, and particularly preferably from 30 to 60.

It is possible to use a screw having a known shape as the screw configuration of the extruder, and it is possible to use, for example, segments of a flight type, a reverse type, a kneading disc type, a distributive mixing type, a pin type, and a dispersive mixing type in combination. The dispersibility of PTFE-containing powder (A) in the resin composition to be obtained increases, the foam moldability is improved, and thus a resin foam excellent in the uniformity, fineness, and denseness of the cell can be easily obtained by the appropriate combination of the segments of a kneading disk type, a distributive mixing type, a pin type, and a dispersive mixing type, for example, in a case in which the L/D of the extruder screw is small.

The extrusion temperature is not particularly limited but is, for example, preferably from 150 to 400° C., more preferably from 160 to 300° C., even more preferably from 170 to 240° C., and particularly preferably from 180 to 200° C. By appropriately setting the extrusion temperature, the mixing action with respect to the molten resin in the extruder works, the dispersibility of PTFE-containing powder (A) in the resin composition to be obtained increases, the foam moldability thereof is improved, and thus a resin foam excellent in the uniformity, fineness, and denseness of the cell can be easily obtained.

### <Foaming Agent>

In the invention, a supercritical fluid is used as a foaming agent.

A supercritical fluid is a substance at a temperature and a pressure that are equal to or higher than the critical points thereof. In general, as for the supercritical fluid, it is not possible to make a distinction between gas and liquid, and the supercritical fluid is considered to exhibit both the diffusibility of gas and the solubility of liquid.

Examples of the substance used as the supercritical fluid may include carbon dioxide and nitrogen. Among them, carbon dioxide (the critical points are as follows: a critical temperature of 31° C. and a critical pressure of 7.4 Mpa) is preferable.

The amount of the supercritical fluid used is not particularly limited.

### <Apparatus for Producing Resin Composition Foam>

The resin composition can be foamed using a known manufacturing apparatus. As the manufacturing apparatus, for example, an apparatus such as a batch type, an extruder type, and an injection molding machine type can be used.

In the case of foaming the resin composition using a batch type apparatus, a resin foam can be produced as follows, for example. A foaming agent (supercritical fluid) is introduced into a container containing a resin composition, the supercritical fluid is dissolved in the resin composition by adjusting the internal pressure and temperature of the container, and then the supercritical fluid is removed by returning the internal pressure of the container to atmospheric pressure while maintaining the desired temperature so as to foam the resin composition, subsequently the resultant is cooled.

The resin foam produced in this manner is, for example, in the form of fine particles and can be produced as a molded body by subsequently fusing the particles together in a mold, and the molded body can be used in various applications. The size of the fine particles can be, for example, from 0.001 to 10000 mm, and is preferably from 1 to 1000 μm, and more preferably from 100 to 10000 μm in consideration of the strength of the molded body to be obtained.

In the case of foaming the resin composition using an extruder type apparatus, a resin foam can be produced as follows, for example. A resin composition is passed through the melt-kneading zone, a supercritical fluid is introduced in the middle of passing the resin composition, the supercritical fluid is dissolved in the resin composition by adjusting the temperature and pressure to the desired degrees, thereafter the resultant is discharged through the capillary with a diameter, for example, from 0.1 to 3 mm provided on the die, the supercritical fluid is removed by returning the pressure to atmospheric pressure while maintaining the desired temperature so as to foam the resin composition, and the resultant is subsequently cooled.

The resin foam produced in this manner can be produced as a sheet-shaped molded body, for example, using a circular type die having an annular lip, and the molded body can be used in various applications.

It is possible to use a commonly known tandem type extruder in order to produce a resin foam, and, for example, two units of extruders can be connected and used as described below.

For example, a resin composition and/or a raw material thereof and a foaming agent can be introduced into the first extruder from a hopper and a side feeder, respectively and mixed together. Thereafter, the mixture can be supplied to the second extruder and discharged from the die.

The production conditions to obtain the resin foam of the invention in this process is not particularly limited, but the following example can be mentioned.

The diameter of the screw of an extruder is, for example, from 10 to 900 mm, the L/D is, for example, from 2 to 400, and the conditions for the first and second extruders can be respectively selected and used.

The barrel temperature of the first extruder can be set to 120 to 300° C., for example, in the case of using the propylene-based resin (B) as the resin component.

The die temperature of the second extruder can be set as the foaming temperature to be described below.

A gradient can be provided to the barrel temperature of the second extruder as a process of adjusting the temperature of the mixture transferred from the first extruder to the die temperature of the second extruder.

For example, it is possible to discharge the mixture in the extruder through the capillary provided on the die of the second extruder and to cool in the air or water or while spraying them.

As the first and second extruders and the screw, it is possible to use, for example, the extruders and the screws manufactured by Brabender and KILLON.

In the case of foaming the resin composition using an injection molding machine type apparatus, a resin foam can be produced as follows. A resin composition is weighed in the compression screw part, a supercritical fluid is introduced in the middle of weighing the resin composition, the temperature and pressure is adjusted to the desired degrees, thereafter the resultant is injected into the mold cavity and cooled by returning the pressure to atmospheric pressure while further expanding the volume of the mold cavity. The resin foam produced in this manner can be used in various applications.

### <Production Conditions>

The resin foam obtained by foaming a resin composition has a structure such as an open cell type in which the interfaces between the cells (pores) interconnect, a closed cell type in which the cells are independent of each other, or a monolith type having through holes partitioned by a partition wall although the details will be described below.

These structures of the resin foam can be easily controlled by the composition, production conditions, or the like of the resin composition. Here, the “production conditions” refers to the dissolution conditions (temperature, time, and pressure) when a foaming agent (supercritical fluid) is dissolved in a resin composition, the foaming condition (temperature) when the resin composition is foamed, or the like.

Incidentally, the composition of the resin composition to be described below takes the case of using the propylene-based resin (B) as the resin component as an example, but the same applies to the case of using a resin component other than the polypropylene-based resin (B).

### (Composition of Resin Composition)

As the composition of the resin composition, it is preferable that the PTFE-containing powder (A) be from 0.001 to 40 parts by mass and the propylene-based resin (B) be from 60 to 99.999 parts by mass (provided that, the total of the PTFE-containing powder (A) and the propylene-based resin (B) is taken as 100 parts by mass.), and it is more preferable that the PTFE-containing powder (A) be from 0.01 to 20 parts by mass and the propylene-based resin (B) be from 80 to 99.99 parts by mass. In addition, it is possible to add a foam regulator (C) if necessary.

Among the compositions described above, in the case of producing a closed cell type resin foam, it is preferable that the PTFE-containing powder (A) be from 0.01 to 10 parts by mass and the propylene-based resin (B) be from 90 to 99.99 parts by mass, and it is more preferable that the PTFE-containing powder (A) be from 1 to 8 parts by mass and the propylene-based resin (B) be from 92 to 99 parts by mass. In addition, the content of the foam regulator (C) is preferably from 0.01 to 40 parts by mass, more preferably from 0.05 to 5 parts by mass, even more preferably from 0.2 to 2 parts by mass, and particularly preferably from 1 to 2 parts by mass with respect to total 100 parts by mass of the PTFE-containing powder (A) and the propylene-based resin (B).

In addition, as another example of the composition for producing a closed cell type resin foam, it is preferable that the PTFE-containing powder (A) be from 0.001 to 0.2 part by mass and the propylene-based resin (B) be from 99.8 to 99.999 parts by mass, it is more preferable that the PTFE-containing powder (A) be from 0.01 to 0.2 part by mass and the propylene-based resin (B) be from 99.8 to 99.99 parts by mass, and it is even more preferable that the PTFE-containing powder (A) be from 0.05 to 0.2 part by mass and the propylene-based resin (B) be from 99.8 to 99.95 parts by mass. In the case of this composition, a desired closed cell type resin foam can be easily produced in some cases even without using the foaming regulator (C).

In the case of producing an open cell type resin foam, it is preferable that the PTFE-containing powder (A) be more than 0.2 part by mass and 1 part by mass or less and the propylene-based resin (B) be 99 parts by mass or more and less than 99.8 parts by mass, and it is more preferable that the PTFE-containing powder (A) be more than 0.2 part by mass and 0.5 part by mass or less and the propylene-based resin (B) be 99.5 parts by mass or more and less than 99.8 parts by mass. In the case of this composition, a desired open cell type resin foam can be easily produced in some cases even without using the foaming regulator (C). In addition, in the case of using an extruder type foaming apparatus, it is preferable that the PTFE-containing powder (A) be from 1 to 8 parts by mass and the propylene-based resin (B) be from 92 to 99 parts by mass.

The composition of the resin composition is not particularly limited in the case of producing a monolith type resin foam, but, for example, it is preferable that the PTFE-containing powder (A) be from 0.001 to 5 parts by mass and the propylene-based resin (B) be from 95 to 99.999 parts by mass, it is more preferable that the PTFE-containing powder (A) be from 0.01 to 1 part by mass and the propylene-based resin (B) be from 99 to 99.99 parts by mass, it is even more preferable that the PTFE-containing powder (A) be from 0.05 to 0.7 part by mass and the propylene-based resin (B) be from 99.3 to 99.95 parts by mass, and it is particularly preferable that the PTFE-containing powder (A) be from 0.05 to 0.2 part by mass and the propylene-based resin (B) be from 99.8 to 99.95 parts by mass. In addition, in the case of this composition, a desired monolith type resin foam can be easily produced in some cases even without using the foaming regulator (C).

### (Dissolution Conditions)

Temperature and Time:

A supercritical fluid is dissolved in the resin composition at a temperature equal to or higher than the glass transition point of the other resin. The supercritical fluid can be dissolved in the resin composition in a short time (for example, 30 minutes or shorter) in a case in which the temperature (dissolution temperature) when the supercritical fluid is dissolved in the resin composition is equal to or higher than the glass transition point of the other resin.

In addition, the supercritical fluid is dissolved in the resin composition over a time longer than 30 minutes in a case in which the dissolution temperature is a temperature lower than the glass transition point of the other resin.

### Pressure:

The pressure when the supercritical fluid is dissolved in the resin composition is not particularly limited but is preferably 7.4 MPa or more in consideration of the critical pressure of carbon dioxide, for example, in the case of using carbon dioxide as the supercritical fluid.

The pressure is more preferably from 7.4 to 30 MPa and even more preferably from 10 to 20 MPa, for example, in the case of producing a resin foam using a batch type apparatus.

In addition, there is a tendency that the expansion ratio increases when the resin composition is foamed by returning the pressure to atmospheric pressure but the cells break or coalesce together as the pressure at the time of dissolution becomes higher. In contrast, there is a tendency that the expansion ratio decreases when the resin composition is foamed by returning the pressure to atmospheric pressure but the breakage and coalescence of the cells are suppressed as the pressure becomes lower. Hence, a desired foam structure can be formed by controlling the pressure.

Specifically, the pressure is preferably from 12 to 20 MPa in the case of producing a closed cell type resin foam using a batch type apparatus. A resin foam having a high expansion ratio tends to be easily obtained particularly when the pressure is 12 MPa or more and less than 16 MPa. In addition, a resin foam excellent in denseness and fineness tends to be easily obtained when the pressure is from 16 to 20 MPa. However, the supercritical fluid is preferably dissolved in the resin composition at a dissolution temperature of from 150 to 157° C. when the pressure is set to from 16 to 20 MPa.

The pressure is preferably from 16 to 20 MPa in the case of producing an open cell type resin foam.

The pressure is preferably from 16 to 20 MPa in the case of producing a monolith type resin foam.

### Injection Amount:

The amount (injection amount) of the supercritical fluid injected into the resin composition is not particularly limited, but it is easy to control the size of the pores of the resin foam to be obtained by adjusting the injection amount. The supercritical fluid is preferably injected at 0.3 part by mass or more with respect to 100 parts by mass of the resin composition, for example, in order to produce a resin foam having an expansion ratio of 1.2 times. At this time, carbon dioxide is preferably used as the supercritical fluid.

### (Foaming Conditions)

Temperature:

A resin composition having a supercritical fluid dissolved therein is foamed when the pressure is returned to atmospheric pressure and thus the supercritical fluid is removed from the resin composition so as to form a resin foam. Alternatively, it is also possible to foam a resin composition by returning the temperature of the resin composition having a supercritical fluid dissolved therein to room temperature, returning the pressure thereof to atmospheric pressure, and then reheating the resin composition.

The resin foam is a resultant obtained by foaming a resin composition containing PTFE and the other resin, and the occurrence of defects such as gas loss, gas pocket, and melt fracture is suppressed. The resin foam can be produced, for example, by dissolving a supercritical fluid in a resin composition composed of the PTFE-containing powder (A) and the resin component and then foaming in a certain temperature range. As the example of such a foaming condition, the temperature (foaming temperature) for foaming the resin composition is a temperature lower than the temperature obtained by adding 15° C. to the thermal deformation starting temperature of the other resin (resin component).

Examples of the thermal deformation starting temperature may include the melting point and glass transition point which are determined by the differential scanning calory measurement. In particular, the melting point is preferably adopted as the thermal deformation starting temperature. For example, in the case of using the propylene-based resin (B) as the resin component, the measurement conditions of the melting point may include the second heating, a temperature rising rate of 5° C./min, and a nitrogen atmosphere. In addition, in the case of using a propylene homopolymer as the propylene-based resin (B), the melting point is, for example, from 140 to 190° C., preferably from 150 to 180° C., more preferably from 160 to 170° C., even more preferably from 163 to 167° C., and particularly preferably 165° C.

For example, in the case of using a propylene homopolymer having a melting point of 165° C. as the resin component, the foaming temperature is lower than 180° C., and the foaming temperature is preferably from 31 to 179° C. in consideration of the critical temperature of carbon dioxide in the case of using, for example, carbon dioxide as the supercritical fluid. A resin foam having a high expansion ratio can be produced when the foaming temperature is lower than 180° C.

Furthermore, the foaming temperature is more preferably from 140 to 175° C. and even more preferably from 150 to 165° C., for example, in the case of using a batch type apparatus for the production of a resin foam.

In addition, the cells tend to break or coalesce as the foaming temperature becomes higher. In contrast, the breakage and coalescence of the cells are suppressed as the foaming temperature becomes lower. In this manner, a desired foam structure can be formed by controlling the foaming temperature.

Specifically, the foaming temperature is preferably from 150 to 165° C. and more preferably from 150 to 157° C. in the case of producing a closed cell type resin foam.

The foaming temperature is preferably from 150 to 165° C. and more preferably from 150 to 157° C. in the case of producing an open cell type resin foam.

The foaming temperature is preferably from 158 to 172° C. and more preferably from 158 to 165° C. in the case of producing a monolith type resin foam.

For example, in the case of producing a closed cell type resin foam using an extruder type foaming apparatus, the temperature of the die by which the resin foam is extruded can be, for example, lower than 160° C., and is preferably lower than 150° C., more preferably lower than 140° C., and even more preferably lower than 120° C. In addition, for example, in the case of producing an open cell type resin foam, the temperature of the die by which the resin foam is extruded is preferably from 145 to 155° C. The temperature of the die corresponds to the foaming temperature.

There is a tendency that the resin foam to be obtained is excellent in denseness and fineness and has a high expansion ratio and a high cell density as the temperature of the die becomes lower. The lower limit value of the die temperature is not particularly limited as long as the extrusion is possible.

Incidentally, the dissolution temperature and the foaming temperature may be the same as or different from each other as long as each of the dissolution temperature and the foaming temperature satisfies the conditions described above.

The operating procedure of the pressure and temperature in the case of producing a resin foam using a batch type apparatus is not particularly limited, but the following operating procedure may be exemplified.

In the case of producing a closed cell type or open cell type resin foam, for example, the internal temperature of the batch type apparatus is heated to a desired value, and then the resin composition is introduced into the apparatus while maintaining the internal temperature thereof and the air in the apparatus is replaced with a supercritical fluid. Subsequently, the supercritical fluid is supplied until the internal pressure of the apparatus becomes a desired value while maintaining the internal temperature (dissolution temperature) of the apparatus, and the supercritical fluid is dissolved in the resin composition by maintaining this state for from 0.01 to 10 hours. Thereafter, the supercritical fluid is removed by returning the pressure to atmospheric pressure so as to foam the resin composition, and subsequently the internal temperature of the apparatus is returned to room temperature so as to cool the resultant.

On the other hand, in the case of producing a monolith type resin foam, for example, the internal temperature of the batch type apparatus is heated to a desired value, and then the resin composition is introduced into the apparatus while maintaining the internal temperature thereof and the air in the apparatus is replaced with a supercritical fluid. Subsequently, the supercritical fluid is supplied until the internal pressure of the apparatus becomes a desired value while maintaining the internal temperature (dissolution temperature) of the apparatus, and the supercritical fluid is dissolved in the resin composition by maintaining this state for from 0.01 to 10 hours. Thereafter, the supercritical fluid is removed by returning the pressure to atmospheric pressure so as to foam the resin composition, and then the internal temperature of the apparatus is returned to room temperature so as to cool the resultant. At that time, the decompression rate can be adjusted by the valve aperture, and can be, for example, from 2 to 20 MPa/sec.

In addition, for example, in the case of producing a closed cell type resin foam using an extruder type foaming apparatus, the injection amount of the supercritical fluid can be adjusted by controlling the pressure for supplying the supercritical fluid. The injected supercritical fluid can be dissolved in the resin composition depending on the conditions of temperature and time. For example, the injection amount of the supercritical fluid is not particularly limited but is preferably from 0.1 to 100 parts by mass, more preferably from 1 to 60 parts by mass, even more preferably from 2 to 40 parts by mass, and particularly preferably from 10 to 30 parts by mass with respect to 100 parts by mass of the resin composition. It is possible to easily produce a resin foam having an expansion ratio of at least more than 1.2 times particularly when the injection amount is 0.3 part by mass or more.

A resin foam excellent in denseness and fineness and having a high expansion ratio and a high cell density tends to be easily obtained along with the injection of the supercritical fluid.

### <Advantageous Effect>

According to the method for producing a resin foam of the invention, first, a supercritical fluid is dissolved in a resin composition containing PTFE and another resin at a temperature (dissolution temperature) equal to or higher than a glass transition point of the other resin or a temperature lower than the glass transition point over a time longer than 30 minutes. Thereafter, the resin composition is foamed by removing the supercritical fluid at a temperature (foaming temperature) lower than a temperature obtained by adding 15° C. to a thermal deformation starting temperature of the other resin and the resultant is subsequently cooled, and thus it is possible to produce a resin foam having a high expansion ratio, excellent in denseness and fineness, and having a high cell density.

In addition, according to the invention, a resin foam having a high expansion ratio (density of resin foam/density of resin composition of raw material) can be produced.

Specifically, a resin foam having an expansion ratio of 50 times or less can be produced. The resin foam to be obtained is advantageous in the weight saving of the product and the resource saving as the expansion ratio is high.

In addition, for example, the density (or the volume to obtain the density) can be measured by a method of immersing the substance in a liquid, and the ratio of the density of a closed cell type resin foam to the density of a resin composition of the raw material may be, for example, from 1.2 to 50 times, and is preferably from 5 to 45 times, more preferably from 10 to 40 times, even more preferably 17 to 37 times, and particularly preferably from 25 to 33 times. The ratio of the density of an open cell type resin foam to the density of a resin composition of the raw material may be, for example, from 5 to 15 times. The ratio of the density of a monolith type resin foam to the density of a resin composition of the raw material may be, for example, from 1 to 2 times.

In addition, according to the method for producing a resin foam of the invention, the structure of a resin foam can be easily controlled by adjusting the production conditions such as the composition of the resin composition, the temperature and pressure when a supercritical fluid is dissolved in a resin composition (dissolution temperature), and the temperature when foaming a resin composition (foaming temperature).

### [Resin Composition Foam]

The resin composition foam (resin foam) of the first aspect of the invention is a resin composition foam obtained by the method for producing a resin foam of the invention described above. Specifically, the resin composition foam is obtained by foaming a resin composition containing PTFE and another resin using a supercritical fluid as a foaming agent under specific conditions. Examples of the resin foam may include a resin foam not containing pores of more than 500 μm and a resin foam having pores formed at an interval of less than 10 m. In addition, examples of the structure of the resin foam may include a closed cell type, an open cell type, and a monolith type.

The resin composition foam (resin foam) of a second aspect of the invention is a resin composition foam having a pore size of less than 50 μm, an expansion ratio of more than 5 times, a cell density of more than 10¹⁰ cells/cm³, and an open cell ratio of more than 90%. The structure thereof is an open cell type.

The resin composition foam (resin foam) of a third aspect of the invention is a closed cell type resin composition foam having a pore size of less than 50 μm, an expansion ratio of more than 30 times, and a cell density of more than 10⁸ cells/cm³.

The resin composition foam (resin foam) of a fourth aspect of the invention is a monolith type resin composition foam having a pore size of less than 50 μm and a plurality of through holes partitioned by a partition wall.

The resin foam of the second to fourth aspects of the invention may be a resin foam obtained by foaming a resin composition containing PTFE and another resin or a resin foam obtained by foaming a resin other than the resin composition, but is preferably a resin foam obtained by foaming a resin composition containing PTFE and another resin.

In addition, the resin foam of the second to fourth aspects of the invention may be a resin foam obtained by the method for producing a resin foam of the invention described above or a resin foam obtained by a method other than the production method, but is preferably a resin foam obtained by the method for producing a resin foam of the invention.

Meanwhile, the structure of the resin foam of the first to fourth aspects of the invention can be confirmed, for example, using an observation means such as a scanning electron microscope (SEM) or an X-ray CT Scan.

The expansion ratio of the resin foam is not particularly limited but is preferably more than 1.8 times. The expansion ratio is preferably more than 1.8 times particularly in the case of a resin foam obtained by foaming a resin composition by batch foaming.

In addition, the expansion ratio is preferably more than 2.3 times, for example, in the case of a closed cell type resin foam. The expansion ratio is preferably 1.2 times or more in the case of a monolith type resin foam. The expansion ratio is preferably 1.2 times or more particularly in the case of a monolith type resin foam obtained by foaming a resin composition by batch foaming.

### <Closed Cell Type Resin Foam>

A closed cell type resin foam means a known form to which the designation thereof is generally applied. Specifically, it is possible to exemplify a structure in which the pores (cells) formed in the resin foam are not connected with each other (not interconnecting) but are independent of each other.

The size of the pore is appropriately determined depending on the application of the resin foam, but, for example, the diameter may be 500 μm or less and is preferably 200 μm or less, more preferably 100 μm or less, even more preferably less than 50 μm, and particularly preferably less than 40 μm. The closed cell type resin foam is advantageous in a balance between material weight saving and mechanical strength, thermal insulating properties, optical reflection properties, acoustic properties, and substance permeation/separation properties particularly when the diameter of the pore is 200 μm or less. In addition, the size of the pores (average diameter) is particularly preferably uniform.

The lower limit value of the diameter is not particularly limited but is preferably 0.1 μm or more, more preferably 1 μm or more, even more preferably 3 μm or more, particularly preferably 10 μm or more, and most preferably 20 μm or more.

The diameter of the pore is determined by the observation of the SEM photograph.

Furthermore, the pores are preferably formed at an interval of less than 10 μm. Denseness and fineness are improved as the pores are formed at an interval of less than 10 μm. The lower limit value of the interval is not particularly limited, and the pores adjacent to each other may be in contact.

Meanwhile, the interval is the distance between the adjacent pores and is determined by the observation of the SEM photograph.

In addition, the cell density of the closed cell type resin foam is preferably more than 10⁵ cells/cm³, more preferably from 10^{5.5} to 10¹⁴ cells/cm³, even more preferably from 10^{5.5} to 10¹⁰ cells/cm³, and particularly preferably from 10⁶ to 10⁸ cells/cm³.

The cell density is determined by measuring the cell (pore) number per unit volume through the observation of the SEM photograph.

The closed cell type resin foam is advantageous in a balance between material weight saving and mechanical strength, thermal insulating properties, optical reflection properties, acoustic properties, and substance permeation/separation properties.

### <Open Cell Type Resin Foam>

An open cell type resin foam means a known form to which the designation thereof is generally applied. Specifically, it is possible to exemplify a structure in which the adjacent pores are not separated from each other but the interfaces thereof interconnect. Among them, it is possible to exemplify, for example, a structure in which the pores of different sizes interconnect. Particularly, it is preferable that the pores of different sizes interconnect regularly at a proportion of 50% or more.

The size of the pores of the open cell type resin foam can be described in the same manner as in the case of the closed cell type above.

The interval of the pores is preferably formed in the same manner as in the case of the closed cell type above.

The cell density of the open cell type resin foam is preferably more than 10⁵ cells/cm³, more preferably from 10^{5.5} to 10¹⁴ cells/cm³, and even more preferably from 10¹¹ to 10¹³ cells/cm³.

The structure of the resin foam can be confirmed by measuring the content of the open cell (interconnecting cell content) in conformity with ASTM D6226-98.

The structure of the resin foam can be determined as the open cell type when the content of the open cell is 60% or more. The content of the open cell is preferably 80% or more and more preferably 95% or more.

The open cell type resin foam is advantageous in thermal insulating properties and substance permeation/separation properties.

### <Monolith Type Resin Foam>

A monolith type resin foam means a known form to which the designation thereof is generally applied. Specifically, it is possible to exemplify a structure having a plurality of through holes partitioned by a partition wall (for example, a structure obtained by removing one component of the cocontinuous structure in a binary polymer blend by a solvent extraction technique or the like).

The size of the pore (distance between the partition walls) of the monolith type resin foam is preferably 200 μm or less, more preferably 100 μm or less, even more preferably less than 50 μm, and particularly preferably less than 40 μm. The monolith type resin foam is advantageous in a balance between material weight saving and mechanical strength, thermal insulating properties, optical reflection properties, acoustic properties, and substance permeation/separation properties particularly when the size of the pore is 200 μm or less. The lower limit value is not particularly limited but is preferably 0.1 μm or more, more preferably 3 μm, even more preferably 10 μm or more, and particularly preferably 20 μm or more. The size of the pore is determined by the observation of the SEM photograph.

The monolith type resin foam is advantageous in a balance between material weight saving and mechanical strength and as a substrate for culturing a cell and a support of the substance permeation/separation membrane.

### <Advantageous Effect>

The resin composition foam of the first aspect of the invention described above is a resin composition foam obtained by the method for producing a resin foam of the invention described above. Specifically, the resin composition foam is obtained by foaming a resin composition containing PTFE and another resin using a supercritical fluid as a foaming agent under specific conditions. The structure (a closed cell type, an open cell type, and a monolith type) of the resin foam is controlled by adjusting the production conditions such as the composition of the resin composition, the dissolution conditions (temperature, time, and pressure), or the foaming conditions (temperature).

The resin foam obtained in this manner has a high expansion ratio, is excellent in denseness and fineness, and has a high cell density.

### <Application>

The resin foam can be used in various applications. Specifically, the resin foam is suitable as a material for weight saving and resource saving, a material excellent in thermal insulating properties, cushioning properties, sound insulating properties, optical reflection effect, and substance permeation/separation properties, and a culture substrate excellent in cell adhesion, and can be used to constitute, for example, buildings, automobiles, appliances, audio products, purification facilities, filters, batteries, solar cells, cell chips, or the like.

### EXAMPLES

Hereinafter, the invention will be described specifically with reference to Examples. However, the invention is not limited thereto.

The various measurement methods and evaluation methods and the raw materials of the resin composition are described below.

Meanwhile, in each Example, the notation “parts” and “%” mean “parts by mass” and “% by mass”, respectively.

### [Measurement and Evaluation Methods]

<Measurement of Expansion Ratio>

The densities of the resin composition used as a raw material and the resin foam obtained were measured and the expansion ratio was determined by the following Equation (2).

Expansion ratio (times)=density of resin foam/density of resin composition (2)

### <Evaluation on Denseness and Fineness>

The structure of the resin foam was observed using a scanning electron microscope (SEM) and the denseness and fineness were evaluated according to the evaluation criteria described below.

A: Pores are formed at an interval of less than 10 μm and pores having a diameter of more than 50 μm are not contained.

B: Pores are formed at an interval of less than 10 μm and pores having a diameter of more than 100 μm are not contained.

C: Pores are formed at an interval of less than 10 μm and pores having a diameter of more than 200 μM are not contained.

x: Pores having a size of more than 200 μm are formed.

—: Pores does not exist almost or exist sparsely.

### <Measurement of Cell Density>

The structure of the resin foam was observed using a scanning electron microscope (SEM) and the cell density (cell (pore) number per unit volume) was determined.

### <Measurement of Open Cell Content>

The open cell content of the resin foam was measured in conformity with ASTM D6226-98.

### <Gas Pocket Suppressing Effect>

The cross-section of the strand of the resin foam obtained by extrusion foaming was observed using a scanning electron microscope (SEM) and the effect of suppressing gas pocket was evaluated according to the evaluation criteria described below.

◯: Pores having a size of more than 200 μm are not observed.

x: Pores having a size of more than 200 μm are formed.

### <Melt Fracture Suppressing Effect>

The appearance of the strand of the resin foam obtained by extrusion foaming was visually observed and the effect of suppressing melt fracture was evaluated according to the evaluation criteria described below.

◯: Strand has a smooth rod shape.

x: Strand is in a tortuous state.

### [Raw Material of Resin Composition]

A propylene-based resin composition containing the raw materials described below was used as the resin composition.
PP resin: polypropylene resin (“polypropylene resin FY4” manufactured by Japan Polypropylene Corporation. The melting point measured by the differential scanning calorimetry (using “DSC2910” manufactured by TA Instruments, under a nitrogen atmosphere, in the second heating, by raising temperature from 0 to 200° C. at 5° C./min) was 165° C. In addition, the glass transition point was 0° C.)
Foam regulator: Talc (“MP10-52” manufactured by MINERALS TECHNOLOGIES Inc., median diameter: 1 μm)

### Example 1

### Production of PTFE-Containing Powder (A)

A mixture of 240 parts of water, 30 parts of dodecyl methacrylate, 28.8 parts of methyl methacrylate, 1.2 parts of ethyl acrylate, 1.5 parts of sodium dodecylbenzenesulfonate, and 0.6 part of n-octyl mercaptan was stirred for 2 minutes at 10,000 rpm using a homomixer, and then passed two times through a homogenizer at a pressure of 30 MPa so as to obtain a stable preliminary dispersion. To this preliminary dispersion, 0.12 part of cumene hydroperoxide was added and stirred thoroughly, and then the mixture was introduced into a separable flask equipped with a thermometer, a nitrogen inlet tube, a cooling tube and a stirrer and the temperature thereof was raised to 60° C. An aqueous solution prepared by dissolving 0.00012 part of ferrous sulfate, 0.00036 part of disodium ethylenediaminetetraacetate and 0.288 part of ascorbic acid in 2 parts of water was added thereto at the time at which the temperature thereof reached to 60° C., and the polymerization was initiated and maintained for 2 hours at 60° C.

Subsequently, 20 parts (in terms of solid matter of tetrafluoroethylene-based polymer) of “full-on AD939L” as a latex of a tetrafluoroethylene-based polymer was added thereto and stirred for 1 hour.

Thereafter, the resultant was raised to 80° C. and 0.5 part of sodium dodecylbenzenesulfonate and an aqueous solution prepared by dissolving 0.00004 part of ferrous sulfate, 0.00012 part of disodium ethylenediaminetetraacetate and 0.096 part of ascorbic acid in 2 parts of water were added thereto, then a monomer mixture of 19.6 parts of methyl methacrylate, 0.4 part of ethyl acrylate, 0.2 part of n-octyl mercaptan was added to the resultant dropwise over 1 hour, and further maintained at the same temperature for 1 hour so as to obtain a latex containing a tetrafluoroethylene-based polymer and an alkyl methacrylate-based polymer. It was confirmed that the rate of polymerization of the monomer was 99.9% or more by gas chromatography.

Subsequently, the latex thus obtained was cooled to 25° C. and added to 320 parts of warm water at 50° C. containing 5 parts of calcium acetate dropwise, and then the temperature of the resultant was raised to 90° C. so as to be precipitated. The precipitate thus obtained was separated, washed, and then dried at 60° C. for 12 hours, thereby obtaining the PTFE-containing powder (A). This is denoted as the modified PTFE (A-1).

### <Preparation of Resin Composition>

Using an extruder (screw: diameter of 27 mm, L/D=40, and co-rotating twin screw, manufactured by Leistritz Advanced Technologies Corp.), 5 parts of the modified PTFE (A-1) as the PTFE-containing powder (A) of a PTFE component and 95 parts of the PP resin as the propylene-based resin (B) of a resin component were melt-kneaded under the conditions of a barrel temperature of 190° C. and a screw rotation number of 50 rpm, thereby obtaining a propylene-based resin composition.

The propylene-based resin composition thus obtained was press-molded into a sheet shape having a thickness of 0.4 mm and a diameter of 15 mm using a press molding machine (manufactured by CARVER, Inc.) under the conditions of a press temperature of 190° C., a press pressure of 10 MPa, and a press time of 5 minutes, thereby producing a resin sheet.

### <Production of Resin Foam>

A heat-resistant container having a pressure control valve was sealed and heated until the internal temperature of the container became 155° C. Subsequently, the resin sheet prepared above was introduced into the container and sealed in the state of maintaining the internal temperature of the container at 155° C. The air in the container was replaced with carbon dioxide, and then carbon dioxide was supplied to the container until the internal pressure thereof reached 14 MPa in the state of maintaining the internal temperature of the container at 155° C. After the pressure reached 14 MPa, this state was kept for 30 minutes so as to dissolve carbon dioxide in the resin sheet.

Subsequently, the internal pressure of the container was returned to atmospheric pressure in the state of maintaining the internal temperature of the container at 155° C. so as to remove carbon dioxide and thus foam the resin sheet, and subsequently the container was immersed in cold water to cool, thereby obtaining a resin foam. Meanwhile, both the temperature (dissolution temperature) when carbon dioxide was dissolved in the resin sheet and the temperature (foaming temperature) when the resin sheet was foamed were 155° C.

The expansion ratio of the resin foam thus obtained was determined. The result is presented in Table 1.

### Examples 2 to 12 and Comparative Examples 1 and 2

The resin foams were produced in the same manner as in Example 1 except changing the temperatures (dissolution temperature and foaming temperature) and the pressure to those presented in Tables 1 and 2, and the expansion ratio thereof was determined. The results are presented in Tables 1 and 2.

TABLE 1

| | | | Example | | | | | | | | | |
|---|---|---|---|---|---|---|---|---|---|---|---|---|
| | | | 1 | 2 | 3 | 4 | 5 | 6 | 7 | 8 | 9 | 10 |
| Composition of | PTFE- | Modified | 5 | 5 | 5 | 5 | 1 | 0.5 | 0.3 | 0.1 | 1 | 0.5 |
| resin | containing | PTFE (A-1) | | | | | | | | | | |
| composition | powder | | | | | | | | | | | |
| (parts by mass) | (A) | | | | | | | | | | | |
| | Propylene- | PP resin | 95 | 95 | 95 | 95 | 99 | 99.5 | 99.7 | 99.9 | 99 | 99.5 |
| | based | | | | | | | | | | | |
| | resin (B) | | | | | | | | | | | |
| | Foam | Talc | 0 | 0 | 0 | 0 | 0 | 0 | 0 | 0 | 0 | 0 |
| | regulator | | | | | | | | | | | |
| | (C) | | | | | | | | | | | |

| | | | | | | | | | | | |
|---|---|---|---|---|---|---|---|---|---|---|---|
| Condition for | Temperature (° C.) | 155 | 160 | 155 | 160 | 155 | 155 | 155 | 155 | 155 | 155 |
| production | Pressure (MPa) | 14 | 14 | 11 | 11 | 14 | 14 | 14 | 14 | 11 | 11 |

| | | | | | | | | | | |
|---|---|---|---|---|---|---|---|---|---|---|
| Expansion ratio (times) | 11 | 5 | 4.6 | 8.3 | 11 | 10 | 9.2 | 8.8 | 2.8 | 1.9 |

TABLE 2

| | | | | | Comparative | |
|---|---|---|---|---|---|---|
| | | | Example | | Example | |
| | | | 11 | 12 | 1 | 2 |
| Composition | PTFE- | Modified | 1 | 0.5 | 5 | 5 |
| of resin | containing | PTFE | | | | |
| composition | powder (A) | (A-1) | | | | |
| (parts by mass) | Propylene- | PP resin | 99 | 99.5 | 95 | 95 |
| | based resin (B) | | | | | |
| | Foam regulator | Talc | 0 | 0 | 0 | 0 |
| | (C) | | | | | |

| | | | | | |
|---|---|---|---|---|---|
| Condition for | Temperature (° C.) | 160 | 160 | 180 | 180 |
| production | Pressure (MPa) | 11 | 11 | 14 | 11 |

| | | | | |
|---|---|---|---|---|
| Expansion ratio (times) | 3.8 | 2.7 | 1.0 | 1.1 |

As can be seen from Tables 1 and 2, the expansion ratio of the resin foams obtained in Examples 1 to 12 was high. In addition, the structure of the resin foams was confirmed to be a closed cell type in which the pores were not connected with but independent of each other by SEM.

On the other hand, the expansion ratio was as low as less than 1.2 times in the resin foams obtained in Comparative Examples 1 and 2 in which carbon dioxide was dissolved in the resin sheet at a dissolution temperature of 180° C. and the resin sheet was foamed at a foaming temperature of 180° C.

### Examples 13 to 18 and Comparative Examples 3 to 6

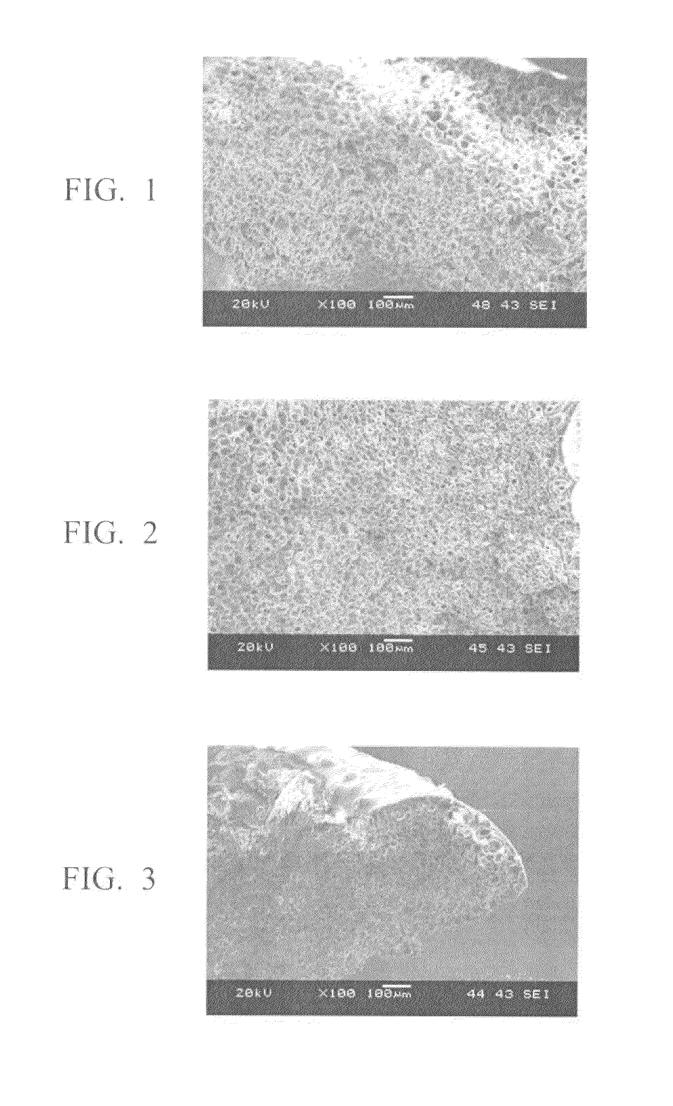

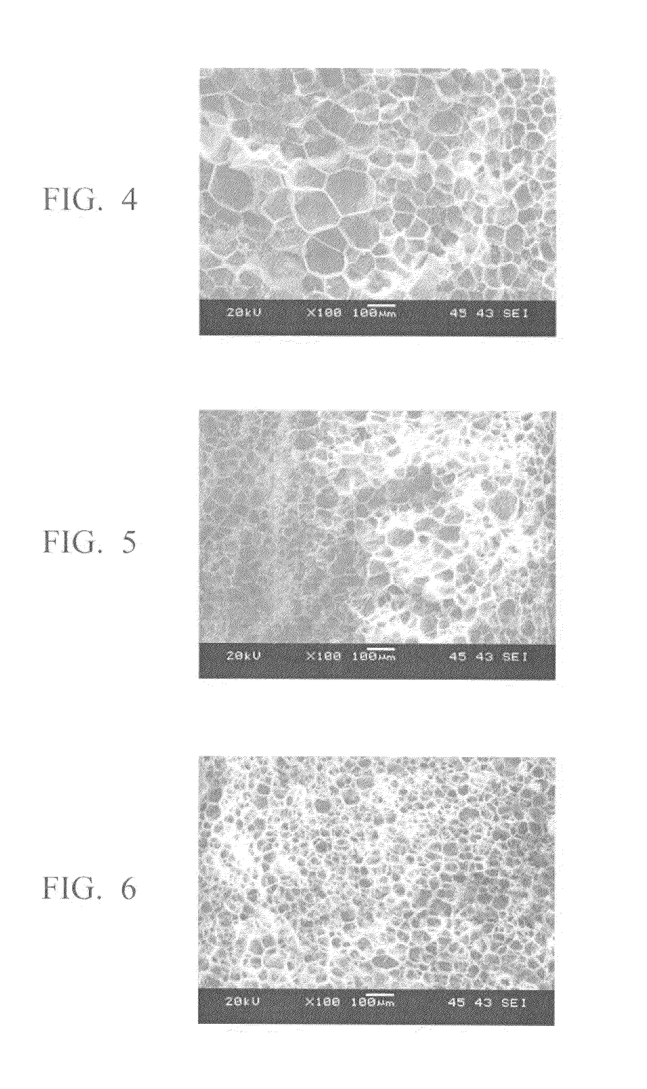

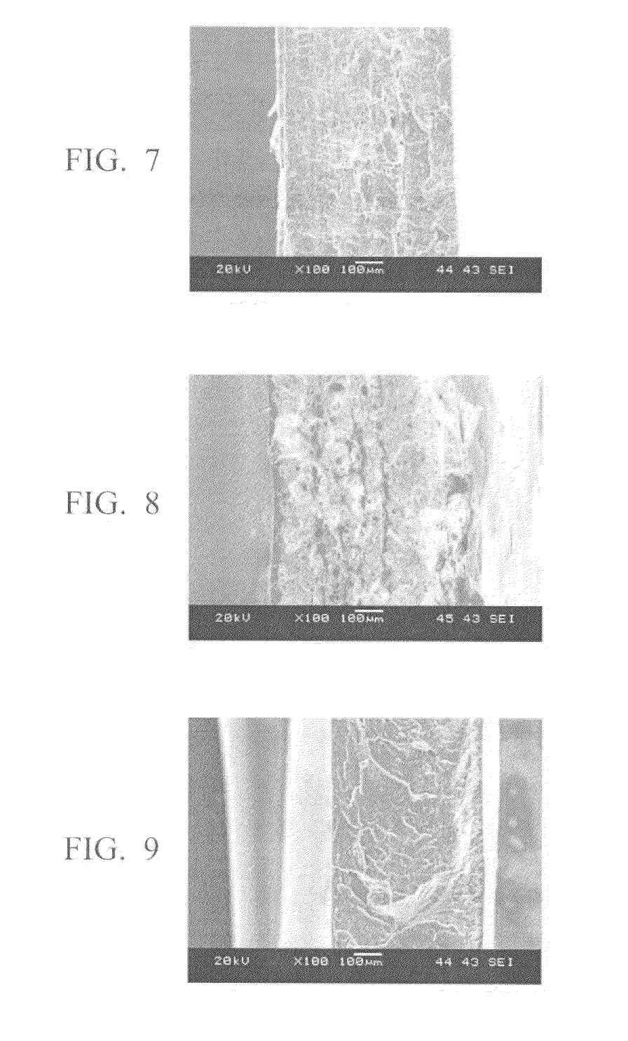

The propylene-based resin compositions were prepared and then the resin foams were produced in the same manner as in Example 1 except changing the compositions of the resin compositions, the temperatures (dissolution temperature and foaming temperature) and the pressure to those presented in Table 3, and the expansion ratio thereof was determined and the denseness and fineness thereof were evaluated. The results are presented in Table 3. In addition, the SEM photographs of the resin foams obtained in Examples 13 to 18 and Comparative Examples 4 to 6 are illustrated in FIGS. 1 to 9.

TABLE 3

| | | | Example | | | | | | Comparative Example | | | |
|---|---|---|---|---|---|---|---|---|---|---|---|---|
| | | | 13 | 14 | 15 | 16 | 17 | 18 | 3 | 4 | 5 | 6 |
| Composition | PTFE- | Modified | 3 | 3 | 3 | 3 | 3 | 3 | 0 | 0 | 0 | 0 |
| of resin | containing | PTFE | | | | | | | | | | |
| composition | powder | (A-1) | | | | | | | | | | |
| (parts by | (A) | | | | | | | | | | | |
| mass) | Propylene- | PP resin | 97 | 97 | 97 | 97 | 97 | 97 | 100 | 100 | 100 | 100 |
| | based | | | | | | | | | | | |
| | resin (B) | | | | | | | | | | | |
| | Foam | Talc | 2.4 | 1.6 | 0.8 | 2.4 | 1.6 | 0.8 | 1.6 | 1.6 | 0 | 1.6 |
| | regulator | | | | | | | | | | | |
| | (C) | | | | | | | | | | | |

| | | | | | | | | | | | |
|---|---|---|---|---|---|---|---|---|---|---|---|
| Condition for | Temperature (° C.) | 155 | 155 | 155 | 155 | 155 | 155 | 155 | 155 | 155 | 155 |
| production | Pressure (MPa) | 18 | 18 | 18 | 14 | 14 | 14 | 18 | 14 | 14 | 11 |

| | | | | | | | | | | |
|---|---|---|---|---|---|---|---|---|---|---|
| Expansion ratio (times) | 3 | 2.5 | 1.6 | 22 | 20 | 9 | 1.5 | 2 | 1.5 | 1.1 |
| Evaluation on denseness and fineness | A | A | A | C | C | B | — | — | — | — |

As can be seen from Table 3 and FIGS. 1 to 9, the resin foams obtained in Examples 13 to 18 had a high expansion ratio and were excellent in denseness and fineness. In particular, the expansion ratio was high in the case of Examples 16 to 18 in which the pressure was 14 MPa, and the denseness and fineness were excellent in the case of Examples 13 to 15 in which foaming was performed at a pressure of 18 MPa. In addition, the structure of the resin foams was confirmed to be a closed cell type in which the pores were not connected with but independent of each other by SEM.

On the other hand, the resin foams obtained in Comparative Examples 3 to 6 in which a resin composition not containing the PTFE-containing powder (A) was foamed were poor in denseness and fineness.

### Examples 19 to 34 and Comparative Examples 7 to 12

The propylene-based resin compositions were prepared and then the resin foams were produced in the same manner as in Example 1 except changing the compositions of the resin compositions, the temperatures (dissolution temperature and foaming temperature) and the pressure to those presented in Tables 4 and 5, and the cell density thereof was determined. The results are presented in Tables 4 and 5. In addition, the SEM photograph of the resin foam obtained in Comparative Example 7 is illustrated in FIG. 10.

TABLE 4

| | | | Example | | | | | | | | | | |
|---|---|---|---|---|---|---|---|---|---|---|---|---|---|
| | | | 19 | 20 | 21 | 22 | 23 | 24 | 25 | 26 | 27 | 28 | 29 |
| Composition | PTFE- | Modified | 3 | 3 | 3 | 3 | 3 | 3 | 3 | 3 | 3 | 3 | 3 |
| of resin | containing | PTFE | | | | | | | | | | | |
| composition | powder | (A-1) | | | | | | | | | | | |
| (parts by | (A) | | | | | | | | | | | | |
| mass) | Propylene- | PP resin | 97 | 97 | 97 | 97 | 97 | 97 | 97 | 97 | 97 | 97 | 97 |
| | based | | | | | | | | | | | | |
| | resin (B) | | | | | | | | | | | | |
| | Foam | Talc | 2.4 | 1.6 | 0.8 | 0 | 2.4 | 1.6 | 0.8 | 0 | 0 | 0 | 0 |
| | regulator | | | | | | | | | | | | |
| | (C) | | | | | | | | | | | | |

| | | | | | | | | | | | | |
|---|---|---|---|---|---|---|---|---|---|---|---|---|
| Condition for | Temperature (° C.) | 155 | 155 | 155 | 155 | 155 | 155 | 155 | 155 | 150 | 160 | 165 |
| production | Pressure (MPa) | 18 | 18 | 18 | 18 | 11 | 11 | 11 | 11 | 11 | 11 | 11 |

| | | | | | | | | | | | |
|---|---|---|---|---|---|---|---|---|---|---|---|
| Cell density (cells/cm³) | 106.8 | 106.8 | 106.4 | 106.3 | 106.5 | 106.5 | 105.5 | 106 | 106.1 | 106.8 | 106.1 |

TABLE 5

| | | | Example | | | | | Comparative Example | | | | | |
|---|---|---|---|---|---|---|---|---|---|---|---|---|---|
| | | | 30 | 31 | 32 | 33 | 34 | 7 | 8 | 9 | 10 | 11 | 12 |
| Composition | PTFE- | Modified | 5 | 5 | 5 | 5 | 5 | 0 | 0 | 0 | 0 | 0 | 0 |
| of resin | containing | PTFE | | | | | | | | | | | |
| composition | Powder | (A-1) | | | | | | | | | | | |
| (parts by | (A) | | | | | | | | | | | | |
| mass) | Propylene- | PP resin | 95 | 95 | 95 | 95 | 95 | 100 | 100 | 100 | 100 | 100 | 100 |
| | based | | | | | | | | | | | | |
| | resin (B) | | | | | | | | | | | | |
| | Foam | Talc | 0 | 0 | 0 | 0 | 0 | 1.6 | 0 | 1.6 | 0 | 0 | 0 |
| | regulator | | | | | | | | | | | | |
| | (C) | | | | | | | | | | | | |

| | | | | | | | | | | | | |
|---|---|---|---|---|---|---|---|---|---|---|---|---|
| Condition | Temperature (° C.) | 170 | 150 | 155 | 160 | 165 | 155 | 155 | 155 | 155 | 150 | 165 |
| for | Pressure (MPa) | | | | | | | | | | | |
| production | | 11 | 14 | 14 | 14 | 14 | 18 | 18 | 11 | 11 | 11 | 11 |

| | | | | | | | | | | | |
|---|---|---|---|---|---|---|---|---|---|---|---|
| Cell density (cells/cm³) | 106.1 | 106.1 | 106.9 | 106.5 | 106.1 | 103.8 | 10 | 104.9 | 10 | 1 | 1 |

As can be seen from Tables 4 and 5, the cell density of the resin compositions obtained in Examples 19 to 34 was high. In addition, the structure of the resin foams was confirmed to be a closed cell type in which the pores were not connected with but independent of each other by SEM.

On the other hand, as can be seen from Table 5 and FIG. 10, the cell density was low in the resin foams obtained in Comparative Examples 7 to 12 in which a resin composition not containing the PTFE-containing powder (A) was foamed.

### Example 35

### Preparation of Resin Composition

A propylene-based resin composition was prepared in the same manner as in Example 1 except changing the modified PTFE (A-1) to 0.1 part and the PP resin to 99.9 parts.

The propylene-based resin composition thus obtained was press-molded into a sheet shape in the same manner as in Example 1 except changing the thickness and diameter of the resin sheet to 1 mm and 10 mm, respectively, thereby preparing a resin sheet.

### <Production of Resin Foam>

A heat-resistant container having a pressure control valve was sealed and heated until the internal temperature of the container became 155° C. Subsequently, the resin sheet prepared above was introduced into the container and sealed in the state of maintaining the internal temperature of the container at 155° C. The air in the container was replaced with carbon dioxide, and then carbon dioxide was supplied to the container until the internal pressure thereof reached 18 MPa in the state of maintaining the internal temperature of the container at 155° C. After the pressure reached 18 MPa, this state was kept for 1 hour so as to dissolve carbon dioxide in the resin sheet.

Subsequently, the internal pressure of the container was returned to atmospheric pressure in the state of maintaining the internal temperature of the container at 155° C. so as to remove carbon dioxide and thus foam the resin sheet, and subsequently the container was immersed in liquid nitrogen to cool, thereby obtaining a resin foam. Meanwhile, both the temperature (dissolution temperature) when carbon dioxide was dissolved in the resin sheet and the temperature (foaming temperature) when the resin sheet was foamed were 155° C.

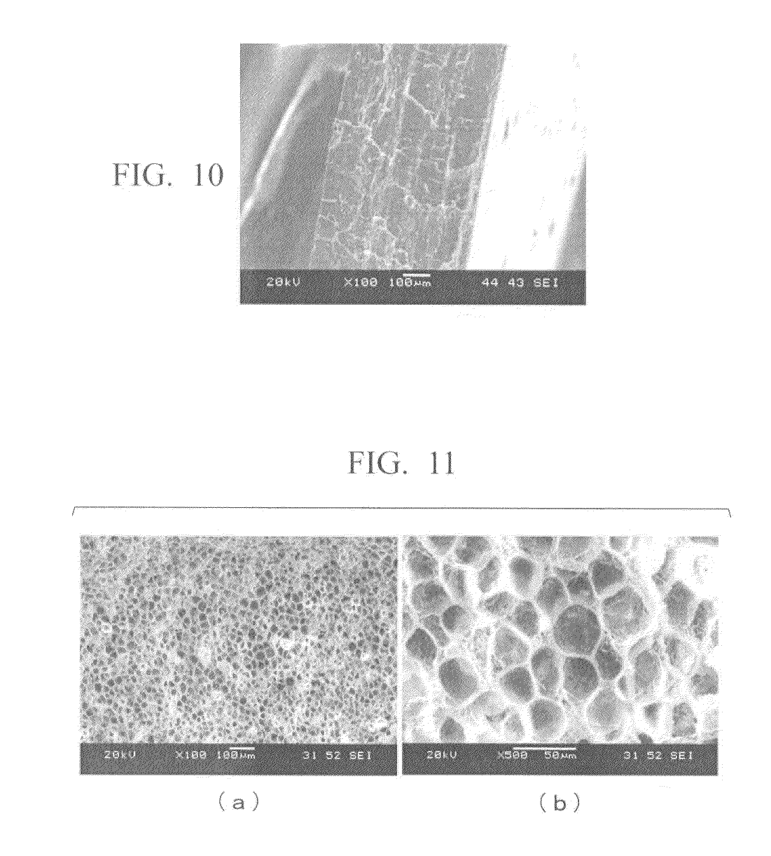

The SEM photograph of the resin foam thus obtained is illustrated in FIG. 11.

As can be seen from FIG. 11, the structure of the resin foam obtained in Example 35 was a closed cell type in which the pores were not connected with but independent of each other and the pores were densely formed.

### Example 36

### Preparation of Resin Composition

A propylene-based resin composition was prepared in the same manner as in Example 1 except changing the modified PTFE (A-1) to 0.3 part and the PP resin to 99.7 parts.

The propylene-based resin composition thus obtained was press-molded into a sheet shape in the same manner as in Example 1 except changing the thickness and diameter of the resin sheet to 1 mm and 10 mm, respectively, thereby preparing a resin sheet.

### <Production of Resin Foam>

A resin foam was obtained in the same manner as in Example 35 except using the resin sheet obtained above.

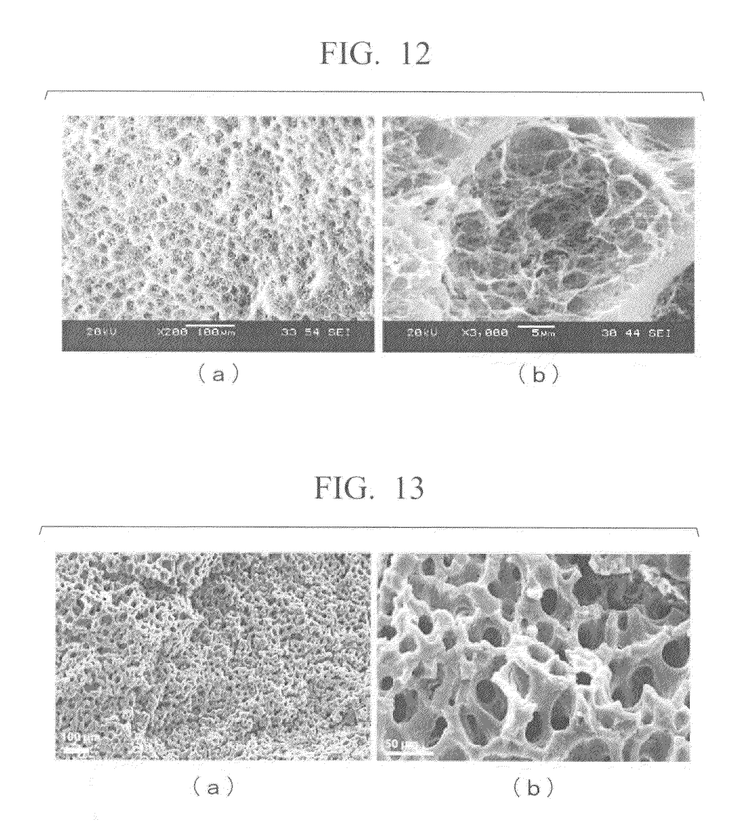

The SEM photograph of the resin foam thus obtained is illustrated in FIG. 12.

As can be seen from FIG. 12, the structure of the resin foam obtained in Example 36 was an open cell type in which large pores were densely formed and small pores were formed on the wall surface of the large pores. In addition, the content of the open cell was 98%.

### Example 37

### Preparation of Resin Composition

A propylene-based resin composition was prepared in the same manner as in Example 1 except changing the modified PTFE (A-1) to 0.1 part and the PP resin to 99.9 parts.

The propylene-based resin composition thus obtained was press-molded into a sheet shape in the same manner as in Example 1 except changing the thickness and diameter of the resin sheet to 5 mm and 15 mm, respectively, thereby preparing a resin sheet.

### <Production of Resin Foam>

A heat-resistant container having a pressure control valve was sealed and heated until the internal temperature of the container became 160° C. Subsequently, the resin sheet prepared above was introduced into the container and sealed in the state of maintaining the internal temperature of the container at 160° C. The air in the container was replaced with carbon dioxide, and then carbon dioxide was supplied to the container until the internal pressure thereof reached 18 MPa in the state of maintaining the internal temperature of the container at 160° C. After the pressure reached 18 MPa, this state was kept for 2 hours so as to dissolve carbon dioxide in the resin sheet.

Subsequently, the internal pressure of the container was returned to atmospheric pressure by releasing carbon dioxide at 15.17 MPa/sec from the container by the adjustment of the leak valve aperture in the state of maintaining the internal temperature of the container at 160° C. so as to remove carbon dioxide and thus foam the resin sheet, and subsequently the contents was taken out from the container and immersed in water to cool, thereby obtaining a resin foam. Meanwhile, both the temperature (dissolution temperature) when carbon dioxide was dissolved in the resin sheet and the temperature (foaming temperature) when the resin sheet was foamed were 160° C.

The SEM photograph of the resin foam thus obtained is illustrated in FIG. 13.

### Example 38

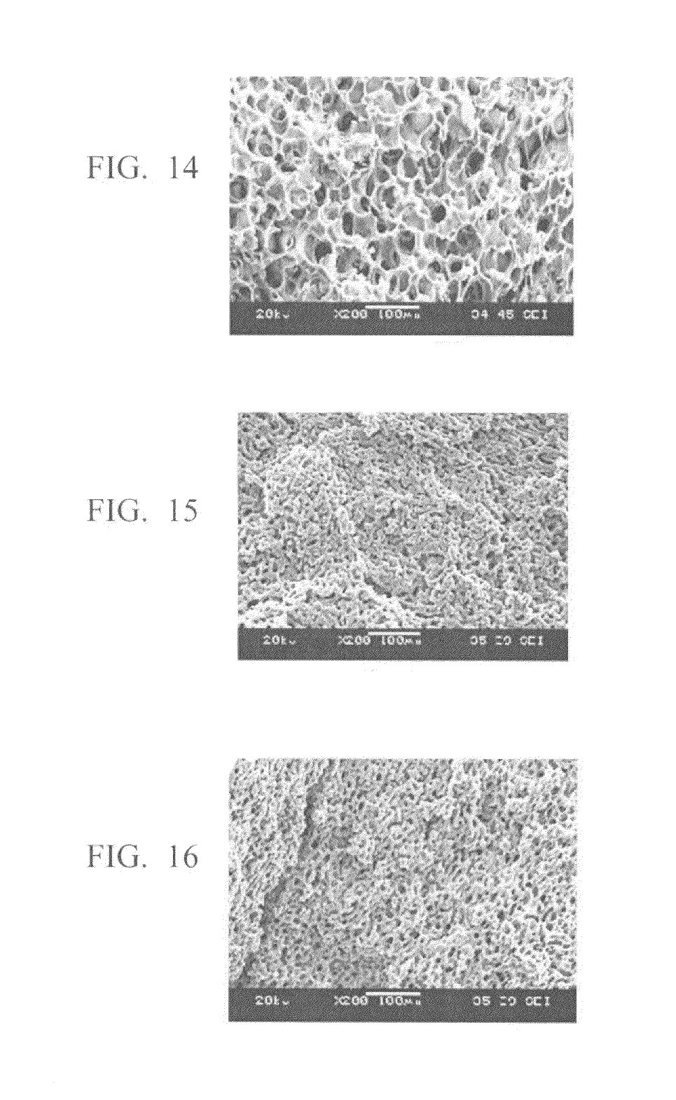

A propylene-based resin composition was prepared and then a resin foam was produced in the same manner as in Example 37 except that the internal pressure of the container was returned to atmospheric pressure by releasing carbon dioxide at 11.72 MPa/sec. The SEM photograph of the resin foam thus obtained is illustrated in FIG. 14.

### Example 39

A propylene-based resin composition was prepared and then a resin foam was produced in the same manner as in Example 37 except changing the modified PTFE (A-1) to 0.5 part and the PP resin to 99.5 parts. The SEM photograph of the resin foam thus obtained is illustrated in FIG. 15.

### Example 40

A propylene-based resin composition was prepared and then a resin foam was produced in the same manner as in Example 37 except changing the modified PTFE (A-1) to 0.7 part and the PP resin to 99.3 parts. The SEM photograph of the resin foam thus obtained is illustrated in FIG. 16.

### Example 41

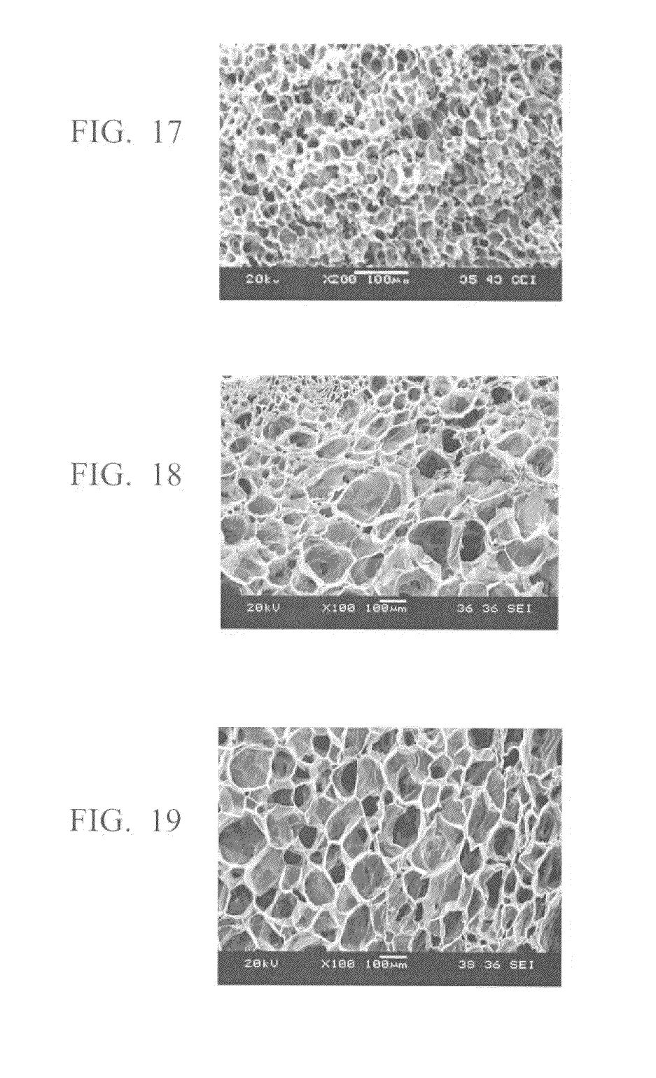

A propylene-based resin composition was prepared and then a resin foam was produced in the same manner as in Example 40 except that the internal pressure of the container was returned to atmospheric pressure by releasing carbon dioxide at 11.72 MPa/sec. The SEM photograph of the resin foam thus obtained is illustrated in FIG. 17.

As can be seen from FIGS. 13 to 17, the structure of the resin foams obtained in Examples 37 to 41 was a monolith type having a plurality of through holes partitioned by a partition wall.

### Example 42

### Preparation of Resin Composition

Using an extruder (screw: diameter of 26 mm, L/D=64.6, and co-rotating twin screw, manufactured by TOSHIBA MACHINE CO., LTD.), 5 parts of the modified PTFE (A-1) as the PTFE-containing powder (A) of a PTFE component and 95 parts of the PP resin as the propylene-based resin (B) of a resin component were melt-kneaded under the conditions of a barrel temperature of 200° C. and a screw rotation number of 200 rpm, thereby obtaining a propylene-based resin composition.

### <Production of Resin Foam>

The following tandem extruder was used.

First extruder: manufactured by Brabender, 05-25-000

(a) screw: diameter of 19 mm, L/D=30 (manufactured by Brabender, 05-00-144)

(b) injection amount of foaming agent (carbon dioxide): presented in Table 6

(c) barrel temperature: 160° C., 220° C., 250° C., and 250° C. from the hopper side, and

(d) screw rotation speed: 5.6 rpm

Second extruder: manufactured by KILLION, KN-150

(a) screw: diameter of 38 mm, L/D=18

(b) die: capillary type (diameter of 1.2 mm, length of 2.54 mm)

(c) die temperature (foaming temperature): 150° C.

(d) barrel temperature (the part connected to the first extruder): 190° C.

(e) barrel temperature (the part except (d)): provided gradient between (c) and (d)

(f) screw rotation speed: 3.4 rpm

The strands obtained by introducing 60 parts of the propylene-based resin composition prepared above and 40 parts of the PP resin (content of the modified PTFE (A-1) after mixing was 3% by mass) through the hopper of the first extruder and extruding from the die of the second extruder at 0.5 kg/hr was cooled in the air. The evaluation results of the resin foam thus obtained is presented in Table 6 and the SEM photograph is illustrated in FIG. 18.

### Examples 43 to 56 and Comparative Examples 13 to 17

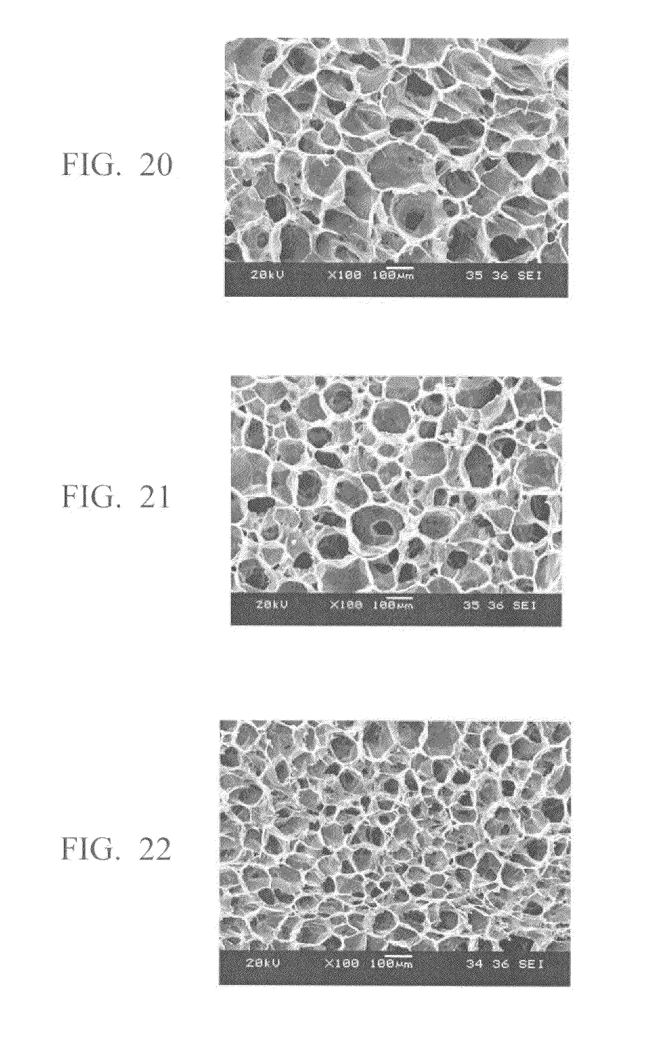

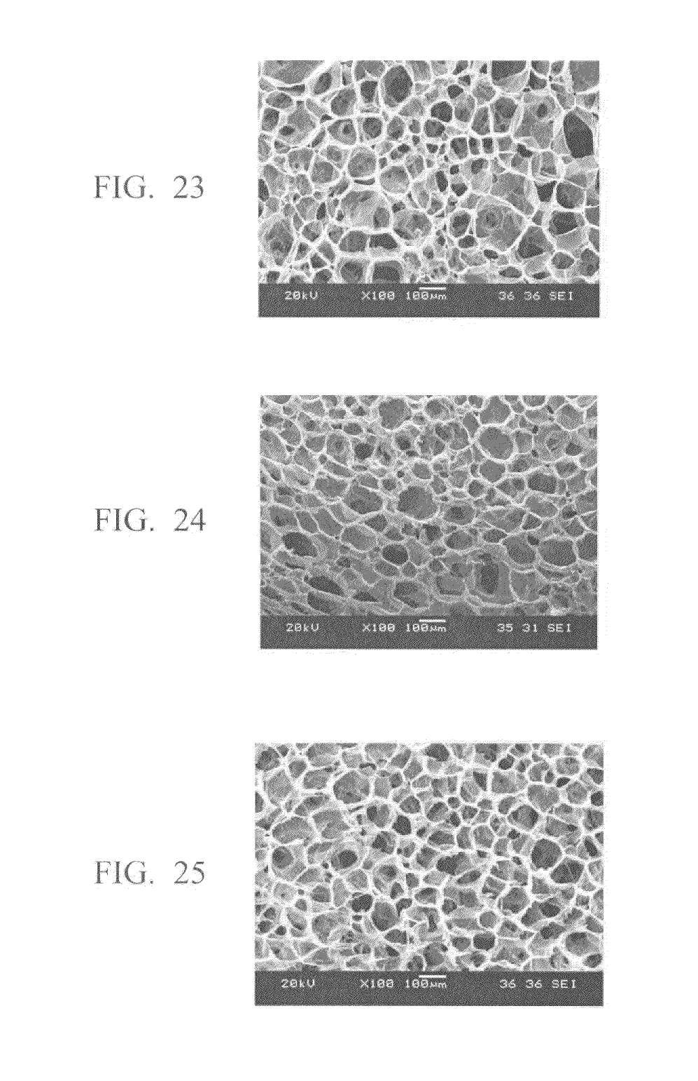

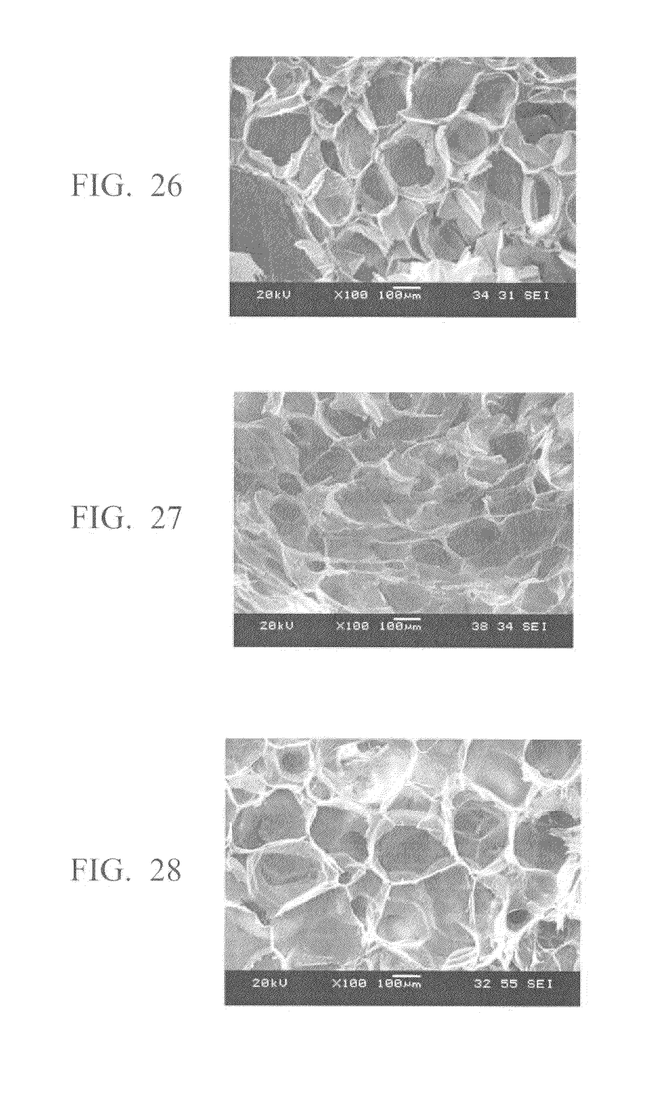

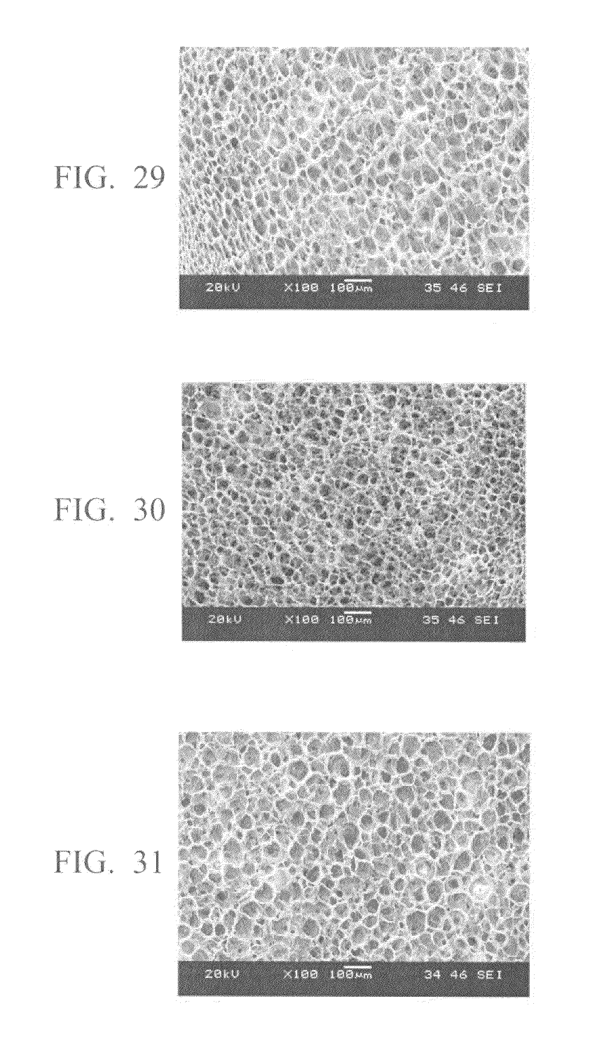

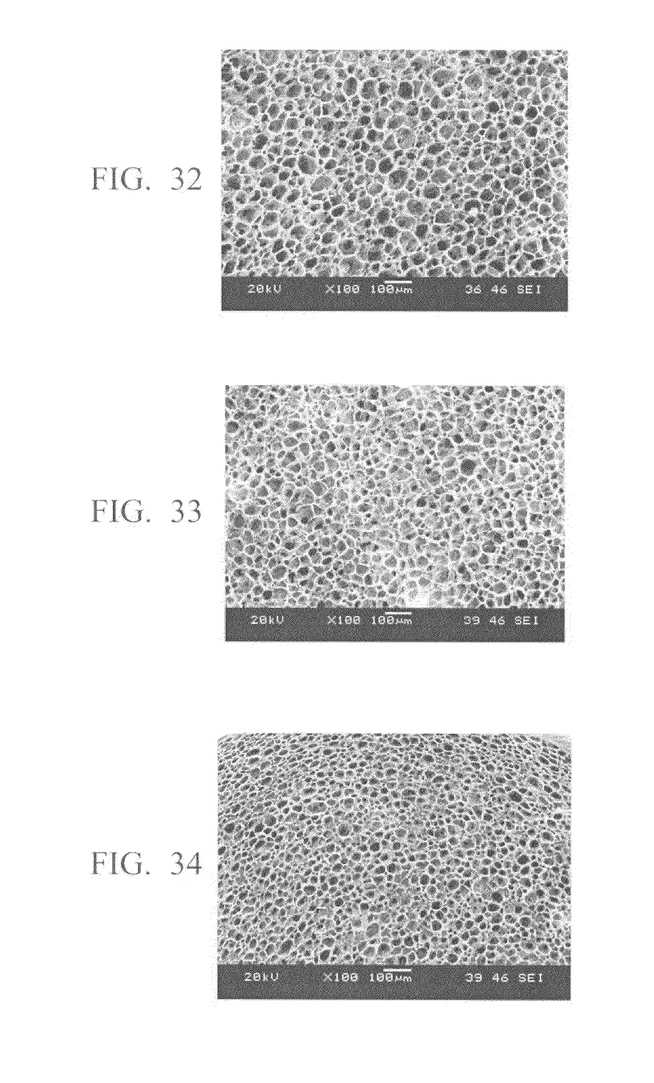

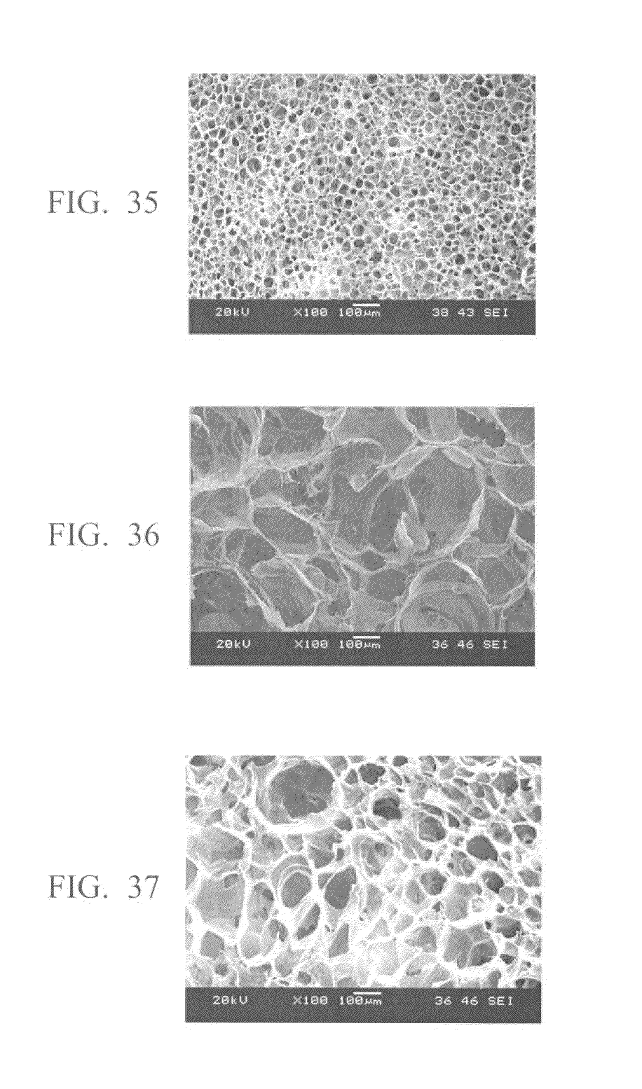

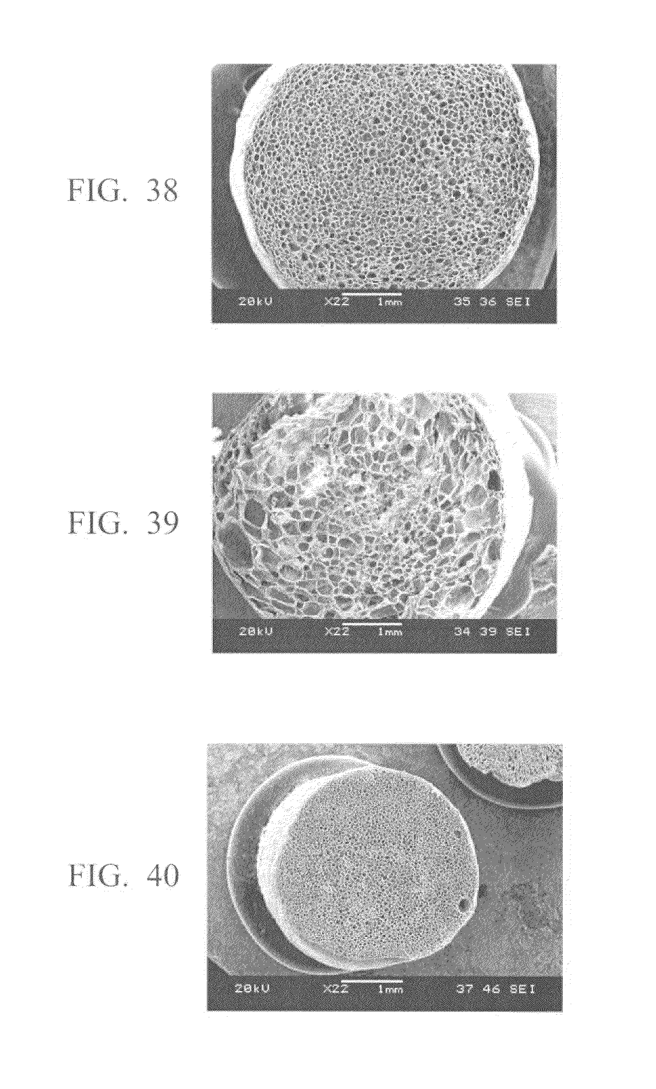

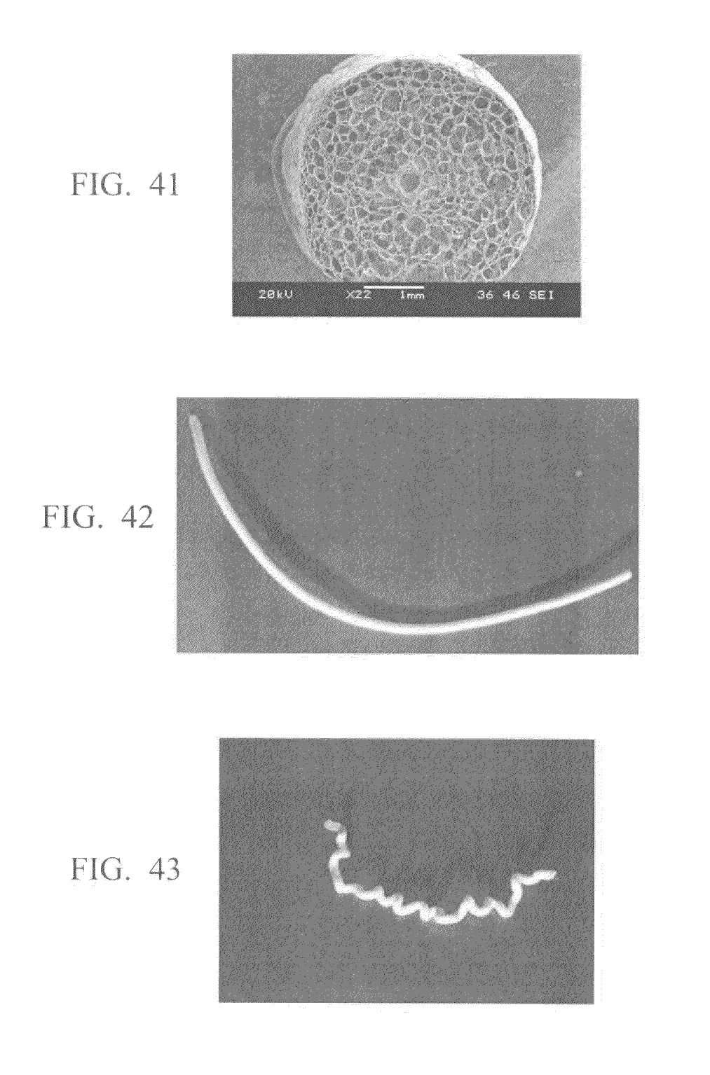

A propylene-based resin composition was prepared and then a resin foam was produced in the same manner as in Example 42 except changing the injection amount of carbon dioxide and the temperature of the die (foaming temperature) to those presented in Tables 6 and 7, the cross-section of the extruded strand of the resin foam was observed to perform the evaluation on gas pocket. In addition, the appearance of the extruded product of the resin foam was observed to perform the evaluation on melt fracture. Moreover, the denseness and fineness of the resin foam was evaluated and the expansion ratio and the cell density were determined. The results of these are presented in Tables 6 and 7. In addition, the SEM photographs of the resin foams obtained in Examples 43 to 56 and Comparative Examples 13 to 17 are illustrated in FIGS. 19 to 37. Furthermore, the SEM photographs of the cross-section of the strands of the resin foams obtained in Example 46 and Comparative Example 13 observed at a low magnification are illustrated in FIGS. 38 and 39 as the representative example of the case of having a small injection amount of carbon dioxide, and the SEM photographs of the cross-section of the strands of the resin foams obtained in Example 51 and Comparative Example 16 observed at a low magnification are illustrated in FIGS. 40 and 41 as the representative example of the case of having a large injection amount of carbon dioxide. In addition, the photographs of the appearance of the strands of the resin foams obtained in Example 52 and Comparative Example 17 observed are illustrated in FIGS. 42 and 43.

TABLE 6

| | | | Example | | | | | | | | Comparative Example | | |
|---|---|---|---|---|---|---|---|---|---|---|---|---|---|
| | | | 42 | 43 | 44 | 45 | 46 | 47 | 48 | 49 | 13 | 14 | 15 |
| Composition | PTEE- | Modified | 3 | 3 | 3 | 3 | 3 | 3 | 3 | 3 | 0 | 0 | 0 |
| of resin | containing | PTFE | | | | | | | | | | | |
| composition | powder | (A-1) | | | | | | | | | | | |
| (parts by | (A) | | | | | | | | | | | | |
| mass) | Propylene- | PP resin | 97 | 97 | 97 | 97 | 97 | 97 | 97 | 97 | 100 | 100 | 100 |
| | based | | | | | | | | | | | | |
| | resin (B) | | | | | | | | | | | | |

| | | | | | | | | | | | | |
|---|---|---|---|---|---|---|---|---|---|---|---|---|
| Condition for | Amount of resin | 97 | 97 | 97 | 97 | 97 | 95 | 95 | 95 | 97 | 97 | 95 |
| production | composition | | | | | | | | | | | |
| | (% by mass) | | | | | | | | | | | |
| | Injection amount of | 3 | 3 | 3 | 3 | 3 | 5 | 5 | 5 | 3 | 3 | 5 |
| | carbon dioxide | | | | | | | | | | | |
| | (% by mass) | | | | | | | | | | | |
| | Temperature of die | 150 | 145 | 140 | 135 | 130 | 140 | 135 | 130 | 145 | 130 | 145 |
| | (° C.) | | | | | | | | | | | |

| | | | | | | | | | | | |
|---|---|---|---|---|---|---|---|---|---|---|---|
| Suppression of gas pocket | ◯ | ◯ | ◯ | ◯ | ◯ | ◯ | ◯ | ◯ | X | X | X |
| Suppression of melt fracture | ◯ | ◯ | ◯ | ◯ | ◯ | ◯ | ◯ | ◯ | X | X | X |
| Denseness and fineness | C | C | C | C | C | C | C | C | X | X | X |
| Expansion ratio (times) | 3 | 13 | 23 | 26 | 25 | 28 | 31 | 30 | 9 | 19 | 19 |
| Cell density (cell/cm³) | 106.3 | 107.3 | 107.4 | 107.6 | 107.9 | 107.7 | 107.7 | 107.8 | 105.8 | 106.4 | 106.4 |

TABLE 7

| | | | Example | | | | | | | Comparative | |
|---|---|---|---|---|---|---|---|---|---|---|---|
| | | | 50 | 51 | 52 | 53 | 54 | 55 | 56 | 16 | 17 |
| Composition | PTFE- | Modified | 3 | 3 | 3 | 3 | 3 | 3 | 3 | 0 | 0 |
| of resin | containing | PTFE | | | | | | | | | |
| composition | powder | (A-1) | | | | | | | | | |
| (parts by | (A) | | | | | | | | | | |
| mass) | Propylene- | PP resin | 97 | 97 | 97 | 97 | 97 | 97 | 97 | 100 | 100 |
| | based | | | | | | | | | | |
| | resin (B) | | | | | | | | | | |

| | | | | | | | | | | |
|---|---|---|---|---|---|---|---|---|---|---|
| Condition for | Amount of resin | 85 | 85 | 55 | 80 | 80 | 80 | 80 | 85 | 85 |
| production | composition | | | | | | | | | |
| | (% by mass) | | | | | | | | | |
| | Injection amount of | 15 | 15 | 15 | 20 | 20 | 20 | 20 | 15 | 15 |
| | carbon dioxide | | | | | | | | | |
| | (% by mass) | | | | | | | | | |
| | Temperature of die | 140 | 135 | 130 | 140 | 130 | 120 | 115 | 140 | 130 |
| | (° C.) | | | | | | | | | |

| | | | | | | | | | |
|---|---|---|---|---|---|---|---|---|---|
| Suppression of gas pocket | ◯ | ◯ | ◯ | ◯ | ◯ | ◯ | ◯ | X | X |
| Suppression of melt fracture | ◯ | ◯ | ◯ | ◯ | ◯ | ◯ | ◯ | X | X |
| Denseness and fineness | B | B | B | B | B | A | A | X | X |
| Expansion ratio (times) | 21 | 28 | 31 | 23 | 33 | 33 | 30 | 19 | 19 |
| Cell density (cells/cm³) | 108.3 | 108.5 | 108.8 | 108.3 | 108.8 | 109 | 109 | 106.4 | 106.6 |

As can be seen from Tables 6 and 7, in the resin foams obtained in Examples 42 to 56, gas pocket and melt fracture were suppressed, denseness and fineness were excellent, and an expansion ratio and a cell density were high. In addition, the structure of the resin foams was a closed cell type.

In particular, the resin foam obtained was superior in denseness and fineness and had a higher expansion ratio and a higher cell density in the case of having a large injection amount of carbon dioxide and/or the case of having a low die temperature (foaming temperature).

On the other hand, the resin foams obtained in Comparative Examples 13 to 17 in which a resin composition not containing the PTFE-containing powder (A) was foamed were poor in denseness and fineness, and gas pocket and melt fracture were observed thereon.

### Example 57

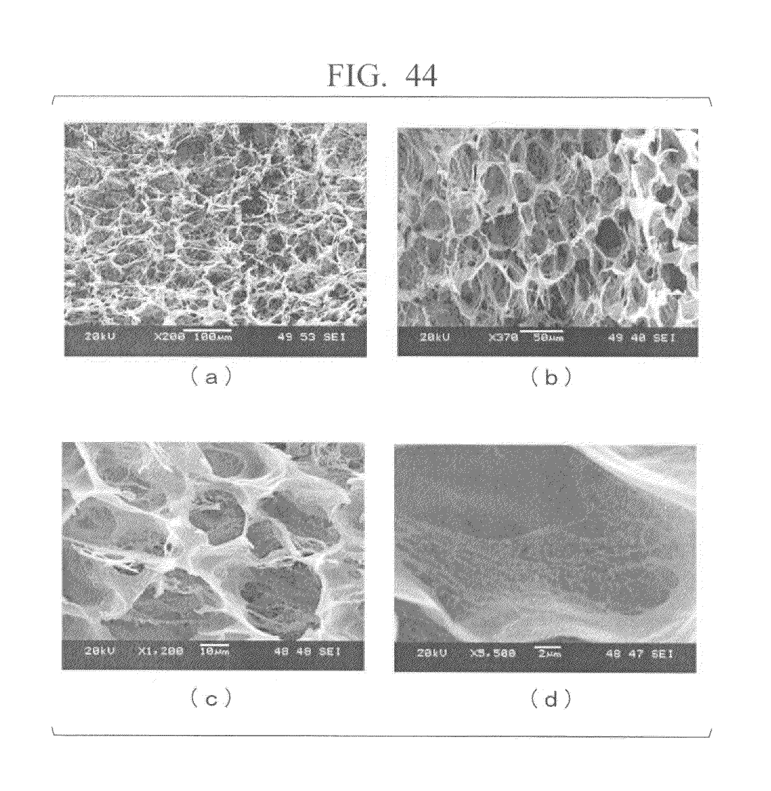

A propylene-based resin composition was prepared and then a resin foam was produced in the same manner as in Example 42 except changing the injection amount of carbon dioxide to 15% by mass and the temperature of the die to 150° C. The SEM photograph of the resin foam thus obtained is illustrated in FIG. 44.

As can be seen from FIG. 44, the structure of the resin foam obtained in Examples 57 was an open cell type in which large pores were densely formed and small pores were formed on the wall surface of the large pores. In addition, the expansion ratio was 12 times, the cell density was 10^{6.9} cells/cm³, and gas pocket and melt fracture were not observed.

From the results Examples 1 through 57 described above, it is indicated that according to the present invention, a resin foam having a high expansion ratio, excellent in denseness and fineness, and having a high cell density can be produced.

In addition, it is also indicated that the structure of the resin foam can be easily controlled by adjusting the composition of the resin composition and the foaming conditions such as the foaming temperature and the foaming pressure.

### INDUSTRIAL APPLICABILITY

According to the method for producing a resin composition foam of the invention, it is possible to produce a resin foam having a high expansion ratio, excellent in denseness and fineness, and having a high cell density by controlling the structure of the resin composition foam.

The resin composition foam of the invention has a high expansion ratio, is excellent in denseness and fineness, and has a high cell density.

1. A method for producing a resin composition foam comprising:
dissolving a supercritical fluid in a resin composition comprising polytetrafluoroethylene and another resin other than polytetrafluoroethylene at a temperature equal to or higher than a glass transition point of the other resin, then
foaming the resin composition by removing the supercritical fluid at a temperature lower than a temperature obtained by adding 15° C. to a thermal deformation starting temperature of the other resin, and subsequently
cooling the resin composition.

2. A method for producing a resin composition foam comprising:
dissolving a supercritical fluid in a resin composition comprising polytetrafluoroethylene and another resin other than polytetrafluoroethylene at a temperature lower than a glass transition point of the other resin over a time longer than 30 minutes, then
foaming the resin composition by removing the supercritical fluid at a temperature lower than a temperature obtained by adding 15° C. to a thermal deformation starting temperature of the other resin, and subsequently
cooling the resin composition.

3. The method of claim 1, wherein the resin composition comprises a foam regulator (C).

4. The method of claim 1, wherein the other resin is an olefin-based resin.

5. The method of claim 1, wherein the other resin comprises a resin which is linear and has a melt flow rate measured in conformity with ISO 1133: 1997 (JIS K 7210: 1999) of more than 0.5 g/10 minutes at 60% by mass or more based on 100% by mass of the other resin.

6. The method of claim 1, wherein the resin composition is foamed by extrusion foaming.

7. A resin composition foam obtained by the method of claim 1, wherein the resin composition foam does not comprise a pore of more than 500 μm.

8. A resin composition foam obtained by the method of claim 1, wherein the resin composition foam comprises pores formed at an interval of less than 10 μm.

9. A resin composition foam obtained by the method of claim 1, wherein the resin composition foam is a closed cell type.

10. The resin composition foam according to claim 9, wherein the resin composition foam is a closed cell type having an expansion ratio of more than 2.3 times.

11. A resin composition foam obtained by the method of claim 1, wherein the resin composition foam is an open cell type.

12. The resin composition foam according to claim 11, wherein the resin composition foam is an open cell type having pores of different sizes interconnected regularly at a proportion of 50% or more.

13. A resin composition foam obtained by the method of claim 1, wherein the resin composition foam is a monolith type having a plurality of through holes partitioned by a partition wall.

14. The method of claim 1, wherein the supercritical fluid is injected at 0.3 part by mass or more with respect to 100 parts by mass of the resin composition.

15. The method of claim 1, wherein the resin composition is foamed by batch foaming.

16. A resin composition foam obtained by the method of claim 15, wherein the resin composition foam has an expansion ratio of more than 1.8 times.

17. A resin composition foam obtained by the method of claim 15, wherein the resin composition foam is a monolith type having an expansion ratio of more than 1.2 times.

18. A resin composition foam, wherein the resin composition foam has a pore size of less than 50 μm, an expansion ratio of more than 5 times, a cell density of more than 10¹⁰ cells/cm³, and an open cell ratio of more than 90%.

19. A resin composition foam, wherein the resin composition foam is a closed cell type having a pore size of less than 50 μm, an expansion ratio of more than 30 times, and a cell density of more than 10⁸ cells/cm³.

20. A resin composition foam, wherein the resin composition foam is a monolith type having a pore size of less than 50 μm and a plurality of through holes partitioned by a partition wall.
